(19) United States
(12) Patent Application Publication
(10) Pub. No.: US 2003/0137975 A1
(43) Pub. Date: Jul. 24, 2003

(54) Ethernet passive optical network with framing structure for native Ethernet traffic and time division multiplexed traffic having original timing

(76) Inventors: Jian Song, San Jose, CA (US); Haixing Shi, Santa Clara, CA (US); Richard H. Chen, Fremont, CA (US)

Correspondence Address: Silicon Valley Patent Group LLP, Suite 360, 2350 Mission College Blvd, Santa Clara, CA, 95054, US

(21) Appl. No.: 10/192,821

(22) Filed: Jul. 9, 2002

Related U.S. Application Data
(60) Provisional application No. 60/304,320, filed on Jul. 10, 2001.

(51) Int. Cl. H04L 12/66

(52) U.S. Cl. 370/353; 370/465; 370/535

(57) ABSTRACT

A passive optical network (PON) carries both telephony traffic and packet-based traffic, each in their native format i.e. without any processing (such as segmentation and reassembly) of either kind of traffic. Specifically, an optical line terminal (OLT) transmits in a time slot of fixed duration (e.g. 125 microseconds or a fraction thereof) a provisionable number (e.g. 0 to 8) frames of fixed size (e.g. T1 frames or E1 frames) in one portion of the time slot, and also transmits a number of frames of variable size in a remaining portion of the time slot. In several embodiments of the invention, the optical line terminal (OLT) determines in real time an integral number of variable size frames that can be transmitted, based on the size of each variable size frame that has been received and is awaiting transmission, and also based on the number of fixed size frames that have been provisioned for the time slot. If an Ethernet frame is still being received or if it has been received but does not fit into the current time slot, then it is not sent in the current time slot, and instead it is sent at the next opportunity (which can occur in the next time slot).

### CROSS-REFERENCE TO RELATED APPLICATIONS

This application is a continuation of and claims priority to the following U.S. Patent Application No. that was filed as a provisional application.

U.S. Patent Application No. 60/304,320 entitled “PON framing structure & ranging process”, filed on Jul. 10, 2001, by Haixing Shi and Jian Song, confirmation no. 9994.

This application is also related to and incorporates by reference herein in its entirety a concurrently filed, commonly owned and copending U.S. Patent Application No. entitled “Allocation of Upstream Bandwidth in an Ethernet Passive Optical Network” filed by Haixing Shi et al, Attorney Docket No. SAL004 US.

Both these patent applications are incorporated by reference herein in their entirety.

### BACKGROUND OF THE INVENTION

In a passive optical network (PON), a number of optical network units (ONUs) are placed in a corresponding number of offices or homes, and are coupled by passive devices to a single optical line terminal (OLT), that may be placed, for example, in a central office of a telephony service provider. Such a passive optical network (PON) may be configured as a single medium that is shared among multiple optical network units (ONUs). The optical line terminal (OLT) may communicate (in the downstream direction) with the multiple optical network units (ONUs) by broadcasting Ethernet packets, as illustrated in FIG. 1. Each optical network unit (ONU) extracts packets addressed to itself based on the media-access-control (MAC) address in the normal manner.

Transmission of the Ethernet packets (in the upstream direction) from multiple optical network units (ONUs) to the optical line terminal (OLT) is coordinated, to avoid collisions (e.g. in case transmissions by two or more optical network units (ONUs) overlap partially) on the shared medium. For example, as noted in an article entitled “Design and Analysis of an Access Network based on PON Technology” by Glen Kramer and Biswanath Mukhejee (that is available on the Internet at //citeseer.nj.nec.coni/509679.html and incorporated by reference herein in its entirety) each of N (e.g. 16) optical network units (ONUs) is assigned a time slot, and each optical network unit (ONU) may transmit any number of packets that may fit within the allocated time slot, as illustrated in FIG. 2. If a packet cannot be completely transmitted within a current time slot, it is transmitted in the next slot.

U.S. Pat. No. 6,324,184 granted to Hou, et al. on Nov. 27, 2001 (that is incorporated by reference herein in its entirety) discloses a time division multiple access (TDMA) frame structure used therein. A transport stream, shown generally at 300 (FIG. 3), includes first, second, and third superframes, denoted by reference numerals 310, 350 and 380, respectively. Each superframe is shown as being comprised of a number NF of frames, although the number of frames need not be the same in each superframe on different channels. In particular, the first superframe 310 includes frames 320, 330 . . . 340, the second superframe 350 includes frames 360, 362 . . . 364, and the third superframe 380 includes frames 390, 392 . . . 394. Furthermore, each frame is shown including a number Nₛ of slots, although the number of slots need not be the same in each frame. For example, the first frame 320 of superframe 310 includes slots 322, 324, 326 and 328. Moreover, the size of each superframe, frame or slot may vary.

U.S. Pat. No. 5,930,262 granted to Sierens, et al. on Jul. 27, 1999 (that is incorporated by reference herein in its entirety) discloses a central station enabled to transmit downstream frames to the terminal stations to allow the terminal stations to transfer upstream frames to the central station in time slots assigned thereto by way of access grant information included in the downstream frames. The downstream frame is a superframe having a matrix structure with rows and columns, and a first portion and a second portion of the matrix structure is an overhead portion and an information portion respectively. The overhead portion includes the access grant information and the size of the overhead portion is flexibly adaptable. The central station and the terminal stations are adapted to send and to interpret the superframe. According to U.S. Pat. No. 5,930,262, bits listed in the downstream frame indicate which terminal station may upon the consecutive zero crossing of its counter transmit an upstream burst.

U.S. Pat. No. 6,347,096 granted to Profumo, et al. on Feb. 12, 2002 (that is also incorporated by reference herein in its entirety) relates to structuring of digital data for transfer in both directions on a passive optical network (PON) in a PON TDMA system. A field is assigned to a block within a multi-frame such that each slot of the block has a digital data format compatible with the synchronous digital hierarchy. The remaining blocks with in a multi-frame have slots assigned to a digital data format compatible with an asynchronous transfer mode system such that digital data from both a broadband source and a narrowband source may be transmitted over the same optical network in an efficient manner.

A presentation entitled “1394 Overview” by Raj Paripatyadar available on the Internet at grouper.ieee.org/groups/802/802_tutorials/nov98/ 1394II_{—}1198.pdf states that as per IEEE 1394, isochronous traffic is handled in 125 microseconds slots and asynchronous traffic uses remaining bandwidth, as illustrated in FIG. 4.

See also a presentation entitled “Ethernet PON (EPON) TDMA Interface in PHY Layer and other considerations” by J. C. Kuo and Glen Kramer, IEEE 802.3 Ethernet in the First Mile (EFM) Study Group, Portland, Oreg., Mar. 2001 available on the Internet at wwwcsif.cs.ucdavis.edu/˜kramer/research.html, that is also incorporated by reference herein in its entirety. See also www.ieee802.org/3/efm/public/ju10/presentations/kramer_{—}1_{—}0701. pdf and grouper.ieee.org/groups/802/3/efm/public/mar01/beili_{—}1_{—}0301.pdf.

### SUMMARY OF THE INVENTION

A passive optical network (PON) in accordance with the invention transmits therethrough both telephony traffic and packet-based traffic, each in their native formats i.e. without any processing (such as segmentation and reassembly) of either kind of traffic. Specifically, an optical line terminal (OLT) transmits in a portion of a time slot of fixed duration (e.g. 125 microseconds or a fraction thereof) a provisionable number (e.g. 0 to 8) frames of fixed size (e.g. T1 frames or E1 frames), and also transmits in a remaining portion of the time slot a number of frames of variable size that carry Ethernet frames.

In several embodiments of the invention, an optical line terminal (OLT) and each of the optical network units (ONUs) in the PON identify in real time an integral number of variable size frames that can be transmitted in a current time slot, based on the size of each variable size frame that has been received and is awaiting transmission, and also based on the number of fixed size frames that have been provisioned for the current time slot. If an Ethernet frame is still being received or if it has been received but does not fit into the current time slot, then it is not sent in the current time slot, and instead it is sent at the next opportunity (which can occur in the next time slot).

### BRIEF DESCRIPTION OF THE DRAWINGS

FIGS. 1 and 2 illustrate, in conceptual views, transfer of information in a downstream direction and in an upstream direction respectively in an Ethernet Passive Optical Network of the prior art.

FIG. 3 illustrates a time division multiple access (TDMA) frame structure used in the prior art for communication by a number of subscriber units in an upstream channel of a communication network, such as a multichannel hybrid fiber coax (HFC) cable television system.

FIG. 4 illustrates, in a block diagram, a prior art method taught by IEEE 1394 wherein isochronous traffic is handled in 125 microseconds slots, and asynchronous traffic uses remaining bandwidth.

FIG. 5A illustrates a time slot in a downstream superframe in accordance with the invention wherein telephony traffic having original timing is transmitted in one portion of the time slot and packet-based traffic in its native format is transmitted in another portion of the time slot.

FIG. 5B illustrates a time slot in a downstream superframe similar to FIG. 5A except that control information is transmitted in a portion of the time slot if the time slot is designated therefor.

FIG. 5C illustrates a downstream superframe that contains time slots of the type illustrated in FIGS. 5A and 5B, and also illustrates an upstream superframe.

FIG. 5D illustrates, in a flow chart, acts performed by an OLT to transmit a superframe containing telephony traffic and packet-based traffic in one particular embodiment.

FIG. 5E illustrates, in a state diagram, acts performed by an ONU to receive a subframe containing telephony traffic and packet-based traffic in one particular embodiment.

FIGS. 6A and 6B illustrate time slots similar to FIGS. 5A and 5B except that these time slots form the upstream superframe of FIG. 5C.

FIG. 6C illustrates, in a state diagram, acts performed by an ONU to transmit a subframe containing telephony traffic and packet-based traffic in one particular embodiment.

FIG. 6D illustrates, in a state diagram, acts performed by an OLT to receive a superframe containing telephony traffic and packet-based traffic in one particular embodiment.

FIGS. 7A and 7B illustrate, in block diagrams, an OLT and an ONU in one embodiment that contain logic (e.g. in an FPGA) to perform the acts illustrated in FIGS. 5D and 6D (by the OLT), and 5E and 6C (by the ONU).

FIG. 7C illustrates, in a high level block diagram, use of the OLT and ONUs of the type illustrated in FIGS. 7A and 7B to implement a PON.

FIGS. 8A-8G illustrate a hardware design for a field programmable gate array for an Optical Line Terminal line card (OLC).

FIGS. 9A-9H illustrate a hardware design for a field programmable gate array for an Optical Network Unit.

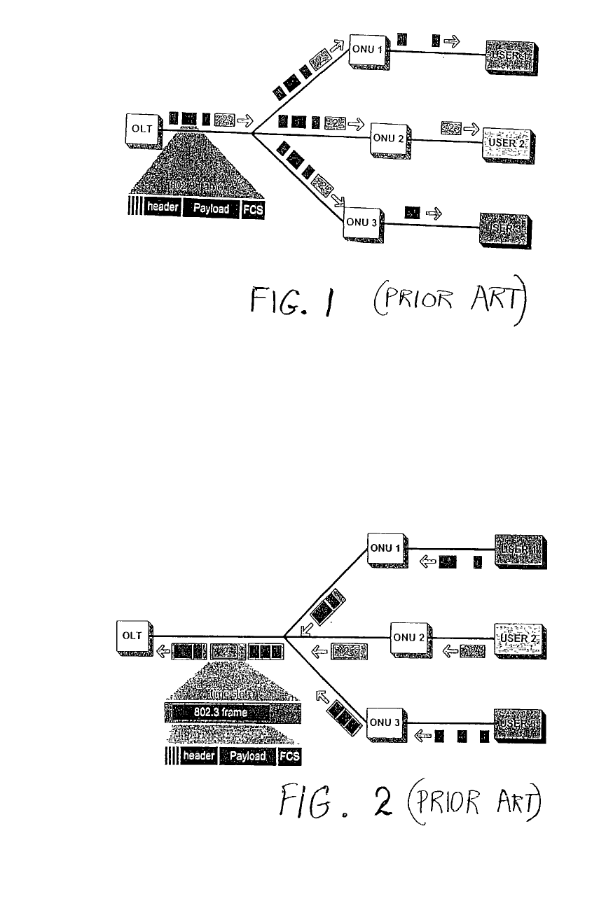

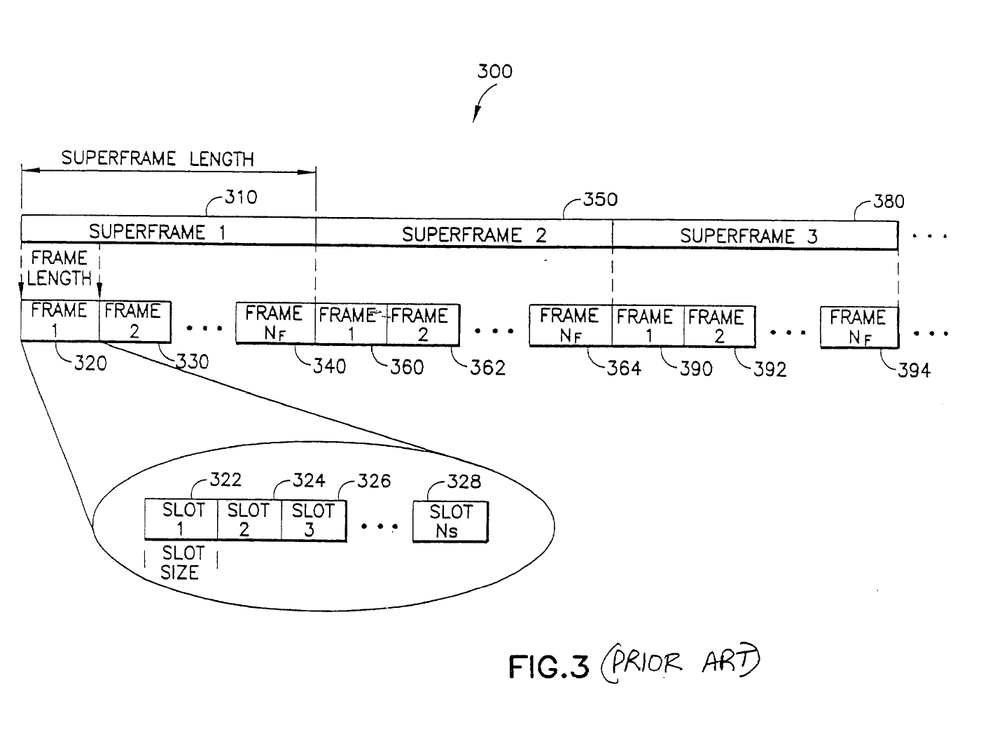

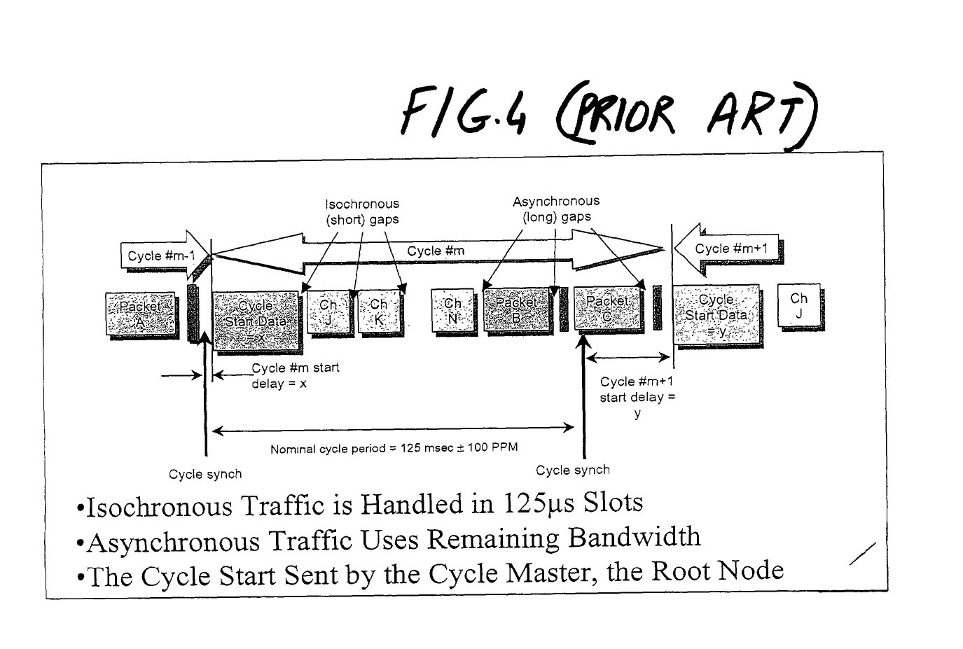

### DETAILED DESCRIPTION

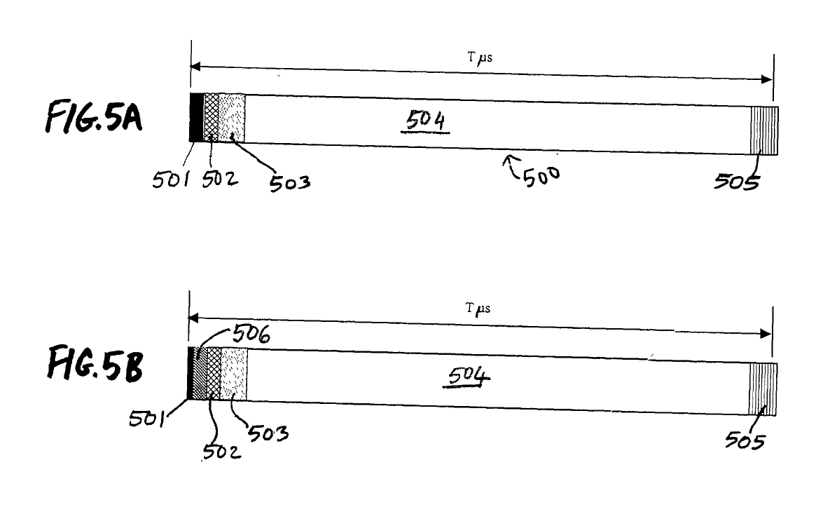

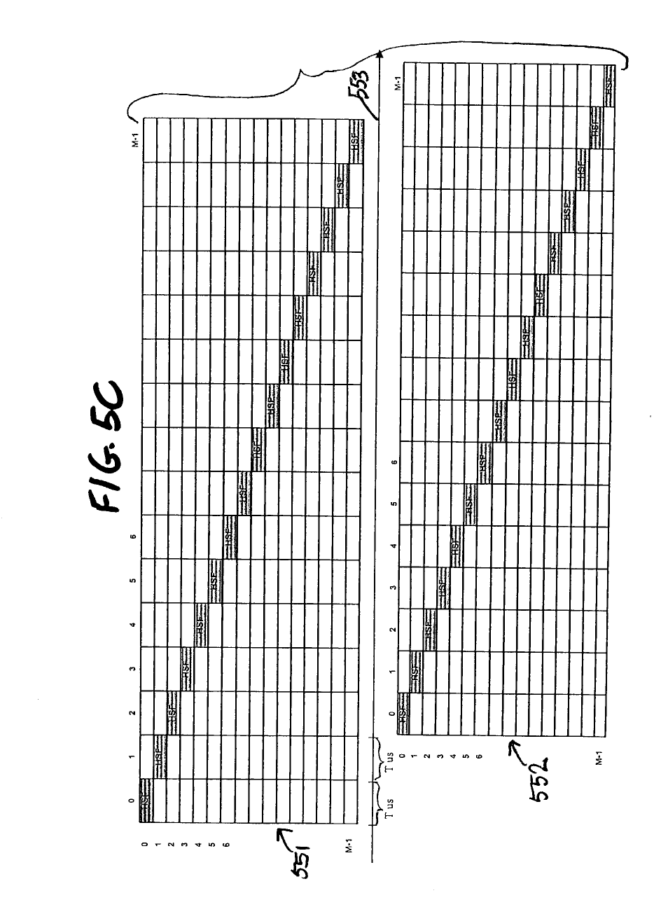

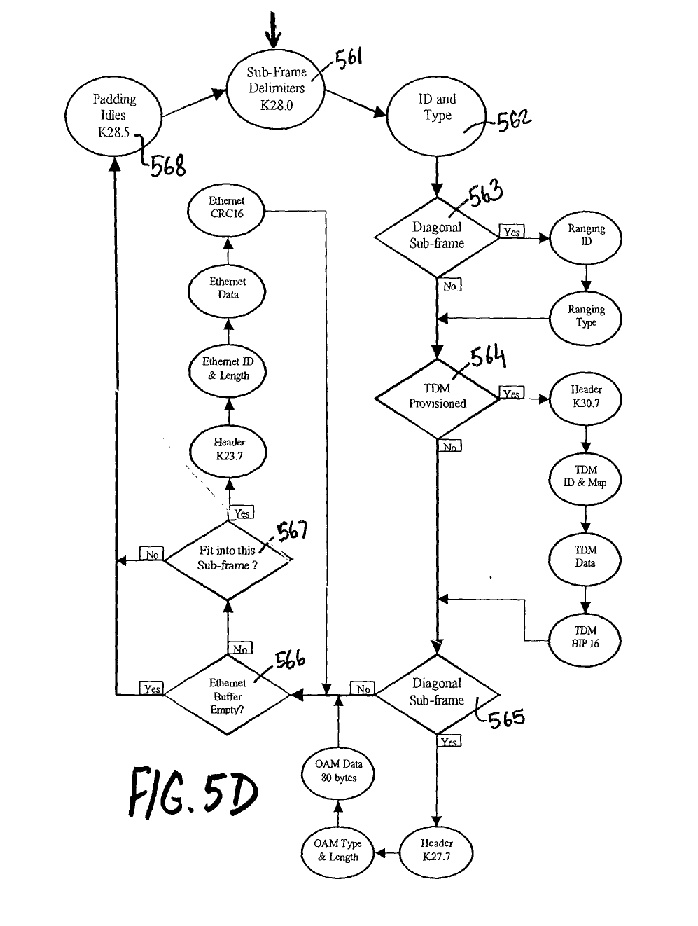

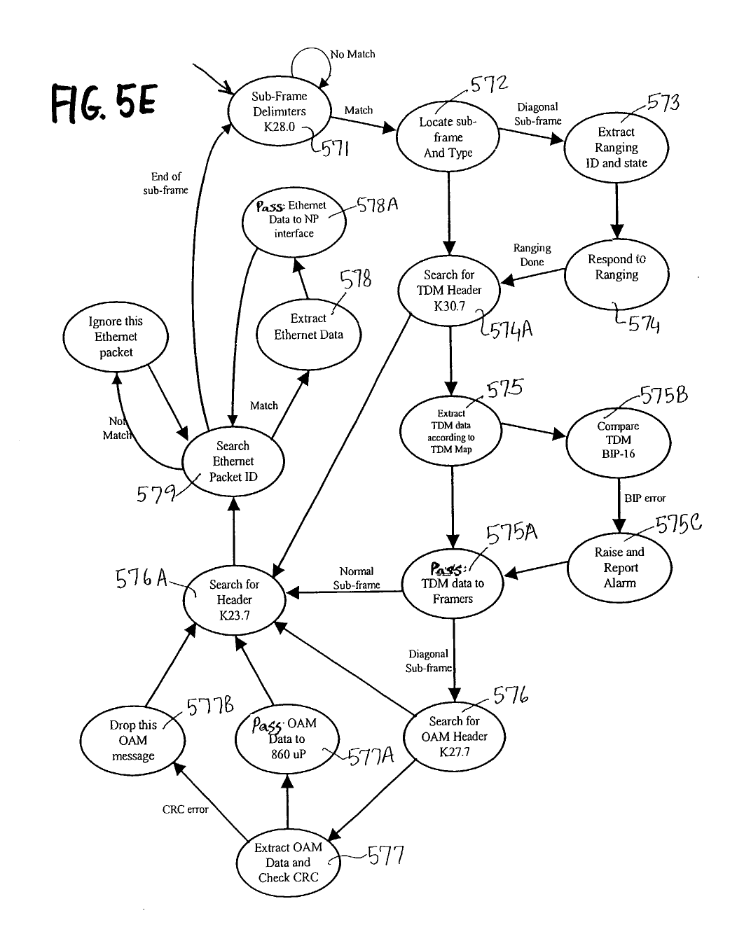

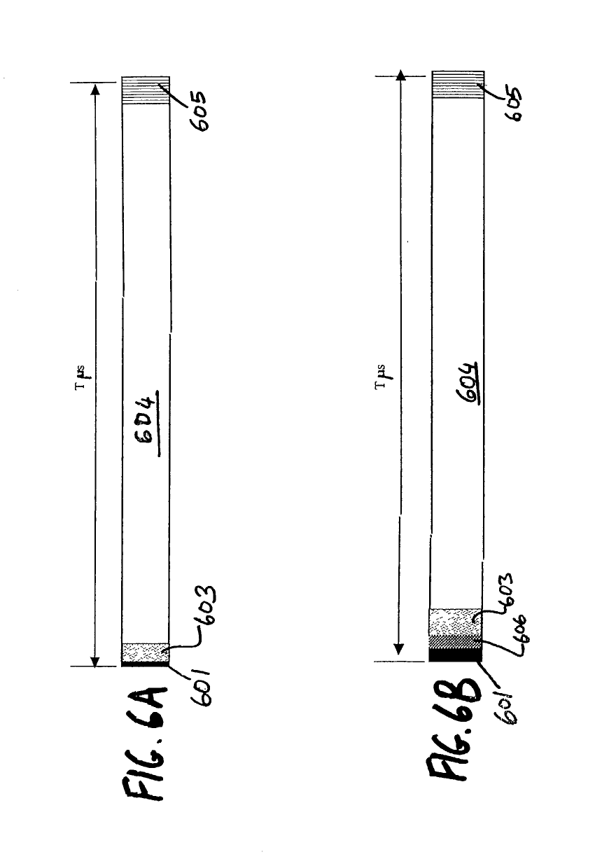

In certain embodiments, one or more fixed size frames that are transmitted through a passive optical network (PON) carry time-division-multiplexed (TDM) traffic 503 (FIG. 5A) with its original timing maintained intact as supplied by an external telephony source that provides the TDM traffic. Specifically, to maintain the original TDM timing intact, time slots during which information is transmitted on the PON (by both OLT and ONU) occur at 125 microsecond intervals. Therefore, in some embodiments the OLT transmits at a rate of 8000 subframes/second in corresponding time slots to the ONUs any TDM traffic that it receives from the TDM network, although in other embodiments the OLT transmission rate may be any integer multiple of 8000 subframes/second. Since each of the ONUs must take turns at transmitting to the OLT when its time slot occurs, each ONU accumulates bytes of TDM traffic and then bursts the TDM traffic when its turn comes.

As used herein the term “time slot” is meant to indicate a unit of duration of time division multiplexing (or time division multiple access sharing) of the PON (e.g. during which an ONU transmits to the OLT and vice versa), and has nothing to do with DS0 time slots.

In addition, the PON of such embodiments transmits therethrough one or more variable size frames that carry Ethernet traffic 504 having a frame structure in compliance with an industry standard, such as IEEE 802.3. Both kinds of traffic are transmitted in the same time slot 500, as illustrated in FIG. 5A. Therefore, such embodiments have the advantage of supporting constant bit rate (CBR) traffic without the overhead associated with cell or packet conversion, and also at the same time supporting variable bit rate (VBR) traffic in native format. To support CBR traffic, the OLT is synchronized with the TDM network clock, and each ONU in the PON is synchronized to the OLT.

At the time of transmission of TDM traffic in a time slot, in some embodiments the ONU or OLT also transmit one or more bits (e.g. the K30.7 character defined in 8B/10B coding scheme) indicating that TDM traffic is to follow (also called “TDM header bits”), thereby to distinguish the TDM traffic from Ethernet traffic that can also be transmitted in the same time slot. In other embodiments, the bytes 503 to be used for TDM traffic are fixed in position and length from the beginning of each time slot and are reserved for TDM traffic, and therefore in such embodiments, no TDM header bits need to be transmitted.

Furthermore, in some embodiments in addition to the TDM header bits, the T1/E1 channels that are to be transmitted in the current time slot are also indicated, e.g. by an identifier of each channel (e.g. by a port number at the ONU), and a map (such as a bitmap) indicating the location of each identified channel in the current subframe. Note that in a PON of several embodiments, TDM traffic is carried in a “tunnel through” mode, and the ONU and OLT do not know whether or not any portion of the TDM bandwidth is unused.

Therefore, in such embodiments, TDM traffic is not encapsulated into an Ethernet frame, nor is there any circuit emulation of the type done in asynchronous transfer mode (ATM) adaptation layer 1 (AAL1). Instead, in several embodiments, TDM traffic 503 (FIG. 5A) is carried by the PON optically using dedicated bandwidth, in fixed-size bit frames all with the same timing of the type normally used in voice circuits, frame relay, T1 or E1. In such embodiments, TDM traffic from any given source occurs periodically at exactly the same location in a subframe, and also occurs in exactly the same set of subframes in every superframe. This is in contrast to circuit emulation of TDM traffic performed by AAL1. So, TDM traffic in certain embodiments of a PON can be configured in accord with the end users' needs for traditional TDM services that conform to a synchronous digital hierarchy such as SONET or SDH.

Furthermore, although TDM traffic 503 must be provisioned, Ethernet traffic 504 need not be provisioned (instead time slots are dynamically allocated automatically), which makes a PON of several embodiments less expensive, since Ethernet is a plug-and-play technology that is well developed, and provides cost savings. Such embodiments leave the TDM traffic 503 in native mode, and simply transmit the native mode TDM traffic 503 on fiber. One advantage is that the TDM support systems continue to work, except that they just report what is happening through the fiber portion and the electrical tail circuits. Moreover, in such embodiments, the PON also reacts in real time to changes in Ethernet traffic 504 to meet dynamic shifts in end user requirements. Therefore, a service provider can go beyond simply setting lower and upper bandwidth limits to accommodate bursty traffic within any given class of service to enabling true bandwidth-on-demand provisioning in accord with class-of-service policies.

Since in the downstream signal is broadcast to all ONUs, a security measure is implemented in some embodiments to ensure that only a specific ONU uses the signal in a specific time slot. Signal integrity of T1/E1 may be guaranteed by implementing an error correction scheme of the type well known in the art. Note that in some embodiments, the PON is considered a transparent TDM link, and all TDM physical link related signaling are terminated and re-generated.

As discussed elsewhere herein, all bytes 504 that remain in a time slot after transmission of TDM bytes 503 may be used to carry native Ethernet data. Multiple bursts of Ethernet, as standard supported, can be transmitted within the same subframe. To improve bandwidth efficiency, Ethernet frames may be re-grouped into a single burst that fits into a subframe.

Prior to transmission of Ethernet traffic, an OLT determines whether or not an Ethernet frame that is currently awaiting transmission is sufficiently small to fit within the bytes remaining to be transmitted in the current time slot. If the entire Ethernet frame cannot be completely transmitted (i.e. without segmentation), then it is transmitted later, and in such a case one or more bytes 505 (FIG. 5A) towards the end of the time slot remain unused. The number of bytes 505 that remain unused changes from time slot to time slot depending on the number of Ethernet frames that have been received and transmitted and their sizes. However, in some embodiments, the number of unused bytes is less than the maximum Ethernet frame size of 1500 bytes plus 26 frame bytes, and 2 VLAN tag bytes.

In addition to the just-described two types of traffic 503 and 504, a time slot 500 may also accommodate other kinds of transmissions, such as transmission of framing 501 (e.g. character K28.0 which identifies the beginning of the subframe), and transmission of broadcast signaling 502 that is meant to be received by all ONUs (e.g. x, y coordinates of the location of the subframe in the entire superframe). Note that in some embodiments, broadcast signaling 502 is not used (i.e. there is no provision for sending a broadcast signal).

In some embodiments if longer broadcast signal is to be transmitted, higher layer processing may segment (i.e. divide up) broadcast signaling messages that are longer than the channel bandwidth provided per frame. A sequence number may be used in such embodiments to assist an ONU to assemble the complete message after receipt. In case of segmented transmission, either hardware or higher layer software may provide forward error checking and/or correction. For content critical messages, higher layer processing may provide acknowledge and re-send requests. Such broadcast messages (in bytes 502) may be used to provide system level time-sensitive signaling, such as system initialization and system re-configuration.

Note that in alternative embodiments, non-time-sensitive broadcast signalling can be sent in an “in-band” fashion, namely between the TDM part and the Ethernet part of the time slot (e.g. for transmission of OAM data for physical or MAC layer initialization or reconfiguration). Data for higher layer initialization and/or reconfiguration may be transmitted in the Ethernet part of the time slot, encapsulated in one or more Ethernet packets.

Framing bits 501 are transmitted by an OLT at the very beginning of a time slot, and define the start of transmission of a subframe. The framing bits 501 provide information for system synchronization. By the OLT's use of different combinations of word/byte characters, the beginning of a superframe, frame and subframe are identified by the ONUs. The ONUs time their own upstream transmissions based on this information. This information may be received, terminated by all alive ONUs, even ones that are not in service. Note that any framing symbols may be used, although in some embodiments, certain framing symbols are selected from the set of COMMA characters available from 8B/10B coding.

Moreover, depending on the location of the time slot in a superframe, a time slot may contain an additional field, for example, signaling 506 that is specific to an ONU, such as ranging, PHY tuning and monitoring. Time slots to be used for ranging are selected to be located along a diagonal of a superframe 551 as illustrated in FIG. 5C, and the bursts in such time slots are also referred to as “header subframes.” Header sub-frames (HSFs) are numbered from 0 to M-1, being one-to-one mapped to up to M ONUs connected to the same PON and hence the same OLT, respectively.

Assume SF(i,j) denotes a subframe in the ith row and jth column in the super frame. The diagonal subframes are defined as HSF_{—m}i=SF(i,i). Because of the broadcasting nature of the downstream transmission, there is no need to group traffic into a certain subframe according to its designated ONU. Therefore, data traffic is groomed by the switch/router, potentially according to the quality of service (QOS) and service level agreement (SLA). The only exception is that the HSF_i carries ranging and link level information for ONU_i. The remaining segments in an HSF and all off-diagonal subframes are used to carry system OAM, data and TDM traffic.

Since signaling 506 is broadcast to all ONUs, certain embodiments use a security scheme to isolate this channel from being eavesdropped by other ONUs. Furthermore, depending on the embodiment, higher layer processing may be performed to segment signaling messages longer than the channel bandwidth provided per frame. A sequence number is then needed for an ONU to assemble the complete message after receiving. Due to the segmented transmission, either hardware or higher layer software may provide forward error checking and/or correction. For content critical messages, higher layer processing may provide acknowledge and re-send requests. Note that signaling 506 may be used for any physical link level management.

Although the diagonal in FIG. 5C runs between the top left corner and the bottom right corner, another diagonal that can be used to allocate ranging slots, which is between the top right comer and the bottom left comer. Note that superframe 551 is transmitted by the OLT in the downstream direction to a number of ONUs. A similar superframe 552 is formed by the bursts of the individual ONUs in the upstream direction (towards the OLT).

In the embodiment illustrated in FIG. 5C, upstream superframe 552 is delayed from downstream superframe 551 by 2T microseconds, wherein T is the duration of a time slot (in which a subframe is transmitted). The delay of 2T microseconds is based on the constant delay time being larger than the time it takes to transmit one subframe, and therefore two consecutive subframes are used to range one ONU. Such delay is long enough to allow a previous ONU to finish TDM transmission, but less than 50 microseconds, to make sure that the ranging process does not take more than two subframes.

Each superframe consists of M rows (also called frames), and each frame in turn consists of M subframes. So, each of superframes 551 and 552 has M*M sub-frames. The transmission data rate in each direction (downstream and upstream) is 1 Gbps. After 8B/10B encoding, the transmission line rate becomes 1.25 Gbps. Each sub-frame has a length of T μs (e.g. 125 microseconds), and carries 1000*T bits (i.e. 125000 bits, which translates to 15,625 bytes).

In some embodiments, TDM bandwidths for different ONUs are assigned in a row-oriented fashion, that is, all bytes 503 in the ith column of the superframe are assigned to ONU_i for transmission of TDM traffic thereto. The T1 frame is 193 bits long (1 framing bit+24*8-bit timeslots) transmitted at a rate of 8000 times per second. Since each sub-frame is T μis long, each T1 burst is TD bits long in a sub-frame. The length of this segment is long enough to carry N×T1 per ONU that has been buffered for M sub-frames. The length is TD * N *M bits. A similar implementation can be made for other TDM types, such as E1.

Other embodiments may introduce a delay of deterministic T*M us (M sub-frames) for the TDM data stream. In such embodiments, instead of carrying TDM traffic for a single ONU, the TDM traffic for all M ONUs is carried in the TDM portion of each sub-frame. The delay has been reduced to T μs for downstream TDM traffic. The length of this segment should be long enough to carry N×T₁ per ONU. The length is TD * N *M bits. A similar implementation can be made for other TDM types, such as E1.

Furthermore, to reduce jitter in TDM traffic, certain embodiments of the type described herein may allocate subframes evenly across the superframe, e.g. may allocate one column at a time, starting with the left most column, and in each column may allocate each subframe from top to bottom.

In some embodiments, an OLT implements the acts illustrated in FIG. 5D in performing downstream transmission of a superframe. Specifically, as illustrated in act 561, the OLT starts with 2 bytes of K28.0 character (as defined in 8B/10B coding) as delimiter. Then, as illustrated in act 562, the OLT sends out the sub-frame ID (which is the location of this subframe in a super frame.); and a subframe type (which is whether or not this subframe is on the diagonal line of a superframe). Note that the subframe type may indicate, for example, that a subframe is carrying only TDM traffic or only Ethernet traffic if some embodiments have dedicated subframes for each kind of traffic.

Next, in act 563, if it is a sub-frame on the diagonal line (i.e. a header subframe), the OLT invokes a ranging message:.two bytes of ranging ID and then 10 bytes of message.

Thereafter, in act 564, if TDM traffics are provisioned in this PON, the OLT starts the TDM frame state machine which transmits the following: two bytes of K30.7 characters, one byte of TDM ID, and another byte that identifies in a bitmap which T1/E1 channels at which positions are active, TDM data N*512 bytes (where N is the number of channels that are active), and an error correcting checksum BIP-16 is used. If TDM traffic channels are not provisioned in this PON, the TDM state machine is not invoked.

Note that in some embodiments of the type described above, if only 4 channels are active the time slots for the remaining 4 channels are available for Ethernet data whereas in other embodiments, the remaining 4 channels are left unused because all 8 channels are dedicated for TDM traffic.

Next, in act 565, if this subframe falls on the diagonal line of a super frame, the OAM state machine is invoked at this time to transmit: two bytes of K27.7 characters, then OAM type (one byte), and OAM message length (also one byte), and then OAM message itself, up to 80 bytes long.

Thereafter, in act 566, after the OAM section, the OLT works on the Ethernet section of a sub- frame. If the Ethernet data buffer has one or more Ethernet packets, the OLT invokes the Ethernet state machine to send the following: two bytes of K23.7 characters, six bits of Ethernet ID, and 10 bits of Ethernet massage length, and Ethernet data frame in variable length, followed by CRC-16 Ethernet checksum. Note that the Ethernet state machine may either lookup the message length from the Ethernet frame or may have to detect the length based on the end of frame (depending on the implementation of Ethernet).

Next, in act 567, if the Ethernet buffer does not have a complete Ethernet packet; or has a complete Ethernet packet but the packet does not fit into the remaining space of a sub-frame, the remaining space in the sub-frame will be padded with idle characters (Y28.5). Then in act 568, at the end of a sub-frame, (when 125 micro-second elapses, in current design.) the cycle starts over again.

In some embodiments, an ONU performs acts in conformance with the state machine illustrated in FIG. 5E to receive TDM and Ethernet traffic from a subframe. It starts (per state 571) with searching for 2 bytes of K28.0 sub-frame header. Once the header is found, it takes the next two bytes of information and locate this current sub-frame in a super-frame (per state 572), and decides whether it is a diagonal sub-frame. If it is a diagonal sub-frame, the ONU extracts the ranging command and the ranging state (as per state 573). If the ranging is not completed yet, the ONU triggers the upstream state machine to respond to ranging command (as per state 574); if the ranging is already done, it starts searching for the TDM header (as per state 574A).

Once the ONU finds the TDM header, the ONU extracts the TDM data based on a map (as per state 575) and passes the data to T1/E1 framers (as per state 575A). If the ONU finds any TDM checksum (BIP-16) as per state 575B during extraction of TDM data, the ONU raises an alarm bit (as per state 575C), and the data still goes to the framers (as per state 575A). The ONU will then search (as per state 576) for K27.7 (OAM header) if the current subframe is a header subframe or search for K23.7 (Ethernet Header) if it is not a header sub-frame (as per state 576A). If it is a header sub-frame, the ONU extracts the OAM data and passes them to the local micro-processor (MPC860) as per state 577A, or drops the message (as per state 577B) if the checksum is incorrect. And starts searching for the Ethernet header (as per state 576A). Once the ONU finds the Ethernet header, it extracts the Ethernet packet (as per state 578), and passes to the network processor (as per state 578A), or drops the packet if the checksum is incorrect. The ONU keeps on searching for additional Ethernet packets (as per state 579), until it reaches the end of a sub-frame at which time the ONU returns to state 571 (discussed above).

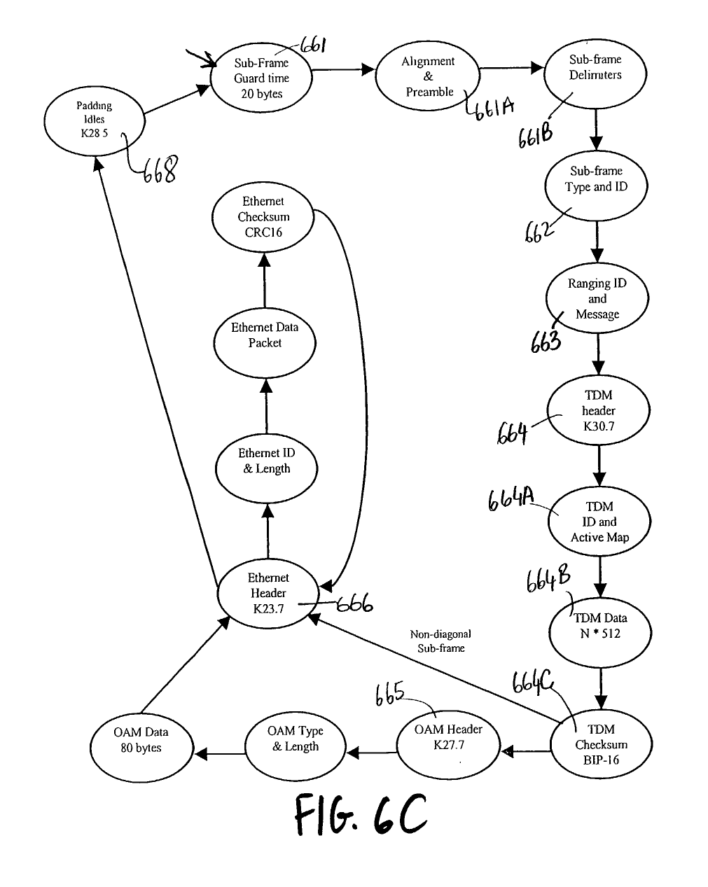

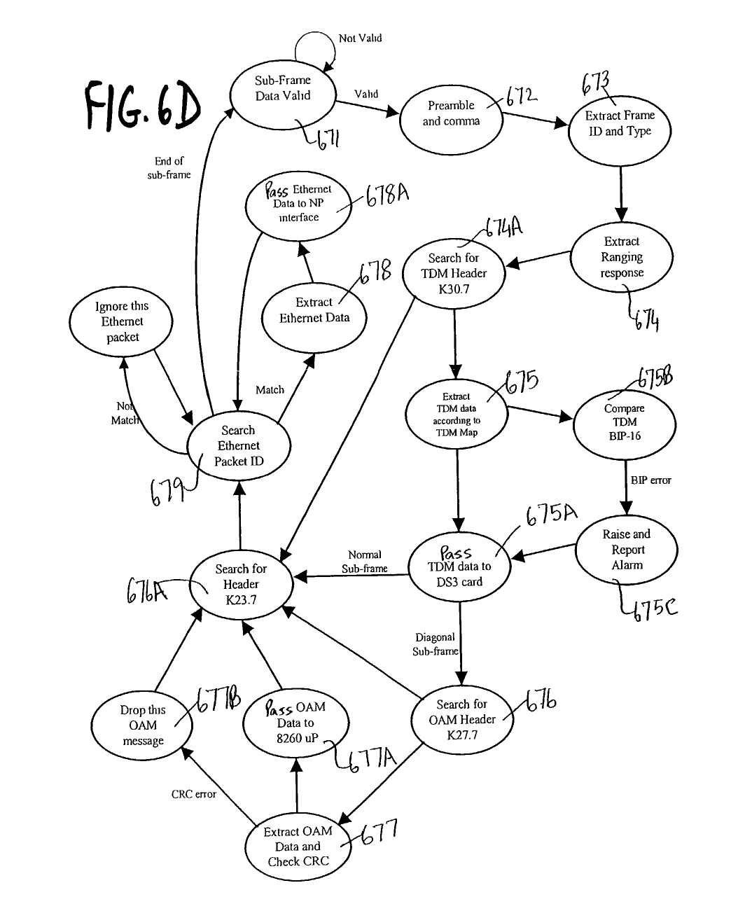

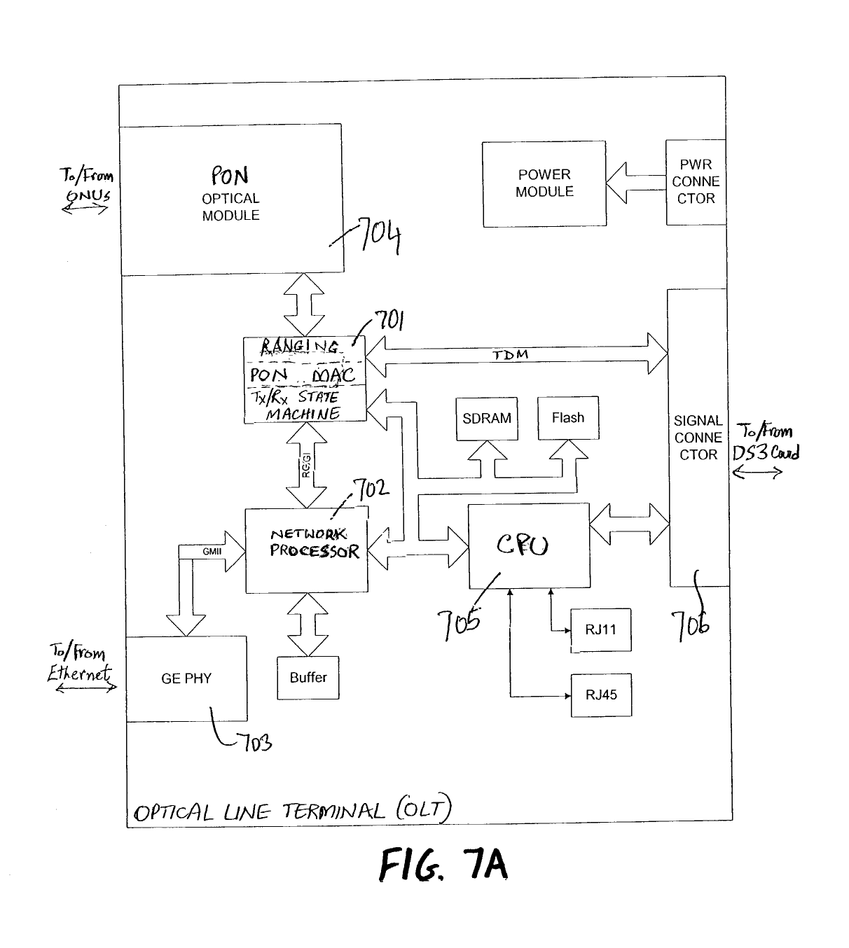

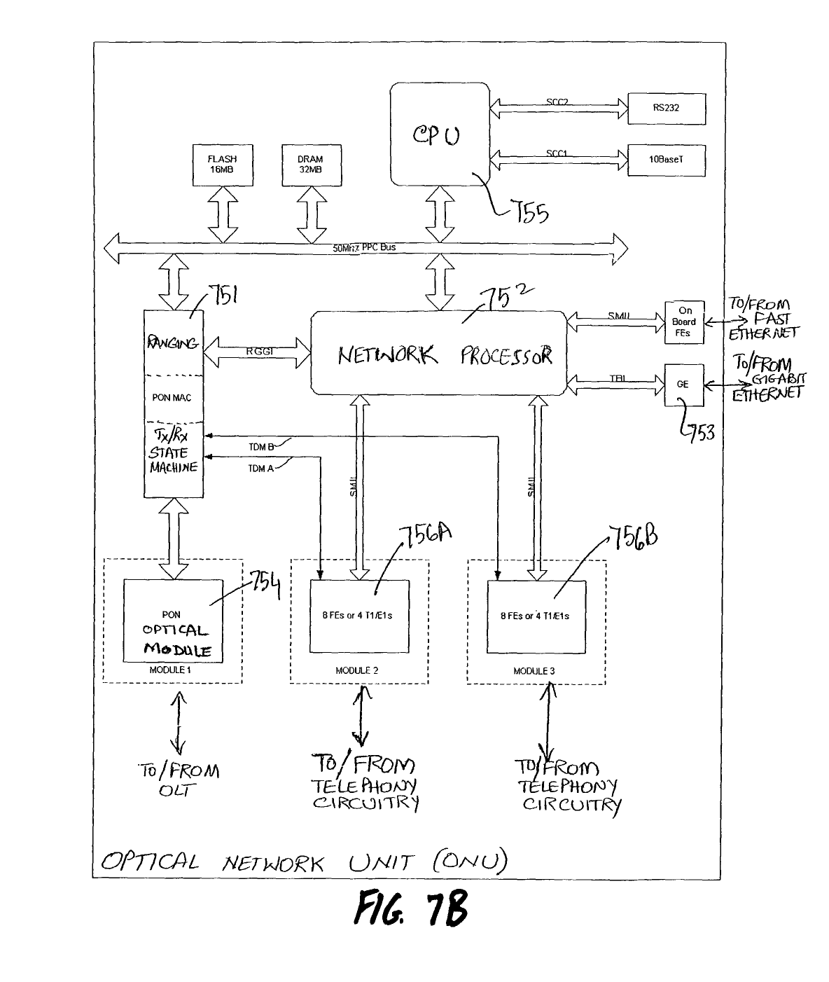

Referring to FIGS. 6A and 6B, although the basic framing structure for upstream transmission on the PON is similar to the downstream transmission, the detailed definitions and usage of sub-frames are the slightly different than those of downstream as noted below.

For example, at the very beginning of each subframe there is guard time to avoid possible overlapped optical transmissions for a tail section of one ONU and the beginning section of the following ONU. The length of this guard time is 100 nanoseconds in one embodiment, which is short enough to maintain the link transition and long enough to tolerant the optical PHY transient characteristics, turn on/off delay and other timing resolution uncertainties. A second time duration (e.g. 40 nanoseconds) following the guard time is used to handle laser turn-on; certain bit patterns can be used as aptitude and/or timing emphasis (pre-distortion) to accelerate the laser turn time.

Then there is a bit sequence as preambles 601 to ensure the burst-mode receiver to complete phase acquisition for bit-synchronization. Specifically, the preambles 601 are used to extract the phase of the arriving sub-frame relative to the local master timing of the OLT, and/or acquire bit synchronization and amplitude recovery. Next, the frame delineators 601 following preambles are selected from the set of COMMA characters to allow word synchronization using a readily available function in most of 8B/10B decoders, called COMMA DETECT. Specifically, a unique pattern indicating the start of a sub-frame may be detected, which can be used to perform byte synchronization.

Note that the just-described guard time length, preamble pattern and delimiter pattern are programmable under the OLT's control. The link level OAM messages in the DS OAM channel define the contents of these fields. For certain embodiments, these fields can be programmed on the ONU locally.

Moreover, ONU specific signaling 606 is used on demand by the system and provides link level management channel for PHY tuning and monitoring, Link OAM and Ranging. As noted above, if the messaging to be done in bytes 606 is longer than the fixed length given by a sub-frame, high layer processing should provide segmentation and re-assembly functionality at two ends. Ranging monitoring and tracking is required either on regular time interval bases or through system CPU intervention during normal operation.

Also, TDM bandwidths for different ONUs are assigned in some embodiments in a row-oriented fashion, that is, all TDM segments in the ith column of the up stream superframe are assigned to ONU_i. In this implementation, each of sub-frames only carries TDM from one ONU. The length of this segment 603 is long enough to carry bytes to carry N×T1 per ONU that has been buffered for M sub-frames. The length is TD * N*M bits, for T1. A similar implementation can be made for other TDM types, such as E1.

The above-described embodiments introduce a delay of deterministic T*M us (M sub-frames) for the TDM data stream. In an alternative embodiment, instead of carrying TDM traffic for a single ONU, the TDM traffic for all ONUs is carried in the TDM portion of each sub-frame. The delay has been reduced in this alternative embodiment to T us for upstream TDM traffic. The length of this segment 603 should be long enough to carry N×T1 per ONU. The length is TD * N *M bits. A similar implementation can be made for other TDM types, such as E1. The just-described alternative embodiment requires that all ONUs burst their TDM traffic in the TDM segment of each sub-frame. The transmitter of the ONU turns on the laser, transmit TD*N bits TDM data and then turns off the laser to let another ONU to transmit its TDM traffic.

As noted above, the remaining bytes 604 of a sub-frame may be used to carry native Ethernet data and system OAM. Multiple bursts of Ethernet, as standard supported, can be transmitted within the same sub-frame. To improve bandwidth efficiency, Ethernet frames can be re-grouped into a single burst (without idles, inter-packet gaps IPG) that fits into a sub-frame. The system OAM data, such as ONU statistics, bandwidth allocation and ONU configuration information will be transmitted with the Ethernet data bursts in the up stream direction. If a Ethernet frame doesn't fit, then some bytes 605 at the end are left unused. The maximal length of unused bytes 605 is shorter than the maximal Ethernet frame of 1,500 byte plus 26 frame bytes and 2VLAN tag bytes.

Acts performed by an ONU for upstream transmission of a subframe (see FIG. 6C) are similar to the corresponding acts performed by an OLT (see FIG. 5D). To illustrate the correspondence and similarity, many reference numerals that are used in FIG. 6C are obtained by adding 100 to the corresponding reference numerals in FIG. 5D. These acts are described briefly next.

The ONU starts with 20 bytes of guard time (as per state 661). Then, the ONU sends out 32 characters of K28.5 idle pattern followed by two bytes of preamble (K28.4) as per state 661A. Next, the ONU sends two bytes of comma (K28.0) characters as subframe delimiters (as per state 661B). Next, the ONU sends sub-Frame type (diagonal or non-diagonal) as per state 662, and also sends sub-frame ID (where it is in a super frame using X, and Y co-ordinates). Next, in state 663, the ONU sends ranging type, ranging state, and ONU_ID; followed by a ranging message. Thereafter, the ONU sends two bytes of K30.7 characters as TDM header (as per state 664), followed by one byte of TDM ID, and a one byte map of how many channels of T1/E1 are active (as per state 664A).

Then the ONU sends TDM data N*512 bytes, where N is the amount of channels active (as per state 664B), followed by a TDM checksum. BIP-16 (as per state 664C). If TDM traffics are not provisioned in this PON, the TDM state machine will not be invoked.

If this sub-frame falls on the diagonal line of a super frame, the OAM state machine will be invoked at this time (as per state 665). The ONU then sends out two bytes of K27.7 characters, then OAM type (one byte), and OAM message length (also one byte), followed by OAM message itself, up to 80 bytes long.

After the OAM section, comes the Ethernet section of a sub-frame. If the Ethernet data buffer has one or more Ethernet packets in it (as per state 666), the ONU invokes the Ethernet state machine to perform the following:

Send out two bytes of K23.7 characters.

Six bits of Ethernet ID, and 10 bits of Ethernet message length.

Then, Ethernet data frame in variable length.

CRC-16 Ethernet checksum.

If the Ethernet buffer does not have a complete Ethernet packet; or has a complete Ethernet packet but the packet does not fit into the remaining space of a sub-frame, the remaining space in the sub-frame will be padded with idle characters (K28.5), as illustrated by state 668. Thereafter, at the end of a sub-frame (when 125 micro-second elapses, in certain embodiments), the cycle starts over again by returning to state 661.

Acts performed by an OLT for upstream receipt of a superframe (see FIG. 6D) are similar to the corresponding acts performed by an ONU (see FIG. 5E). To illustrate the correspondence and similarity, many reference numerals that are used in FIG. 6D are obtained by adding 100 to the corresponding reference numerals in FIG. 5E. These acts are described briefly next.

The OLT initially searches or awaits for the data valid signal to become asserted (as per state 671) and then looks for preamble and comma characters (as per state 672). Once the comma characters are found, the OLT takes the next two bytes of information (called frame ID and type) and uses them to locate this current sub-frame in a super-frame, and decides whether it is a diagonal sub-frame (as per state 673). Thereafter, the OLT extracts the ranging message and determines the ONU's ranging state (as per state 674).

Then the OLT looks for TDM header (as per state 674A), and extracts the TDM data and passes the data to a buffer connected to DS3 line card (as per act 675). If it finds any TDM checksum (BIP-16) as per state 675B, the OLT raises an alarm bit (as per state 675C), and the data is still sent to the buffer on the DS3 line card (as per state 675A). Next, the OLT searches for the character K27.7 (OAM header) as per state 676, if the current subframe is a diagonal sub-frame; or searches for character K23.7 (Ethernet Header) as per state 676A, if it is not a header sub-frame. If it is a diagonal sub-frame, the OLT extracts the OAM data and passes them to the local micro-processor (MPC8260) as per state 677A, or drops the message if the checksum is incorrect as per state 677B. And starts searching for the Ethernet header as per state 676A.

Once it finds the Ethernet header, it extracts the Ethernet packet as per state 678 and passes to the network processor as per state 678A or drops the packet if the checksum is incorrect. The ONU keeps searching (as per state 679) for additional Ethernet packets until it reaches the end of a sub-frame at which time the state machine transitions to state 671 (which is the state machine's first state, and is discussed above).

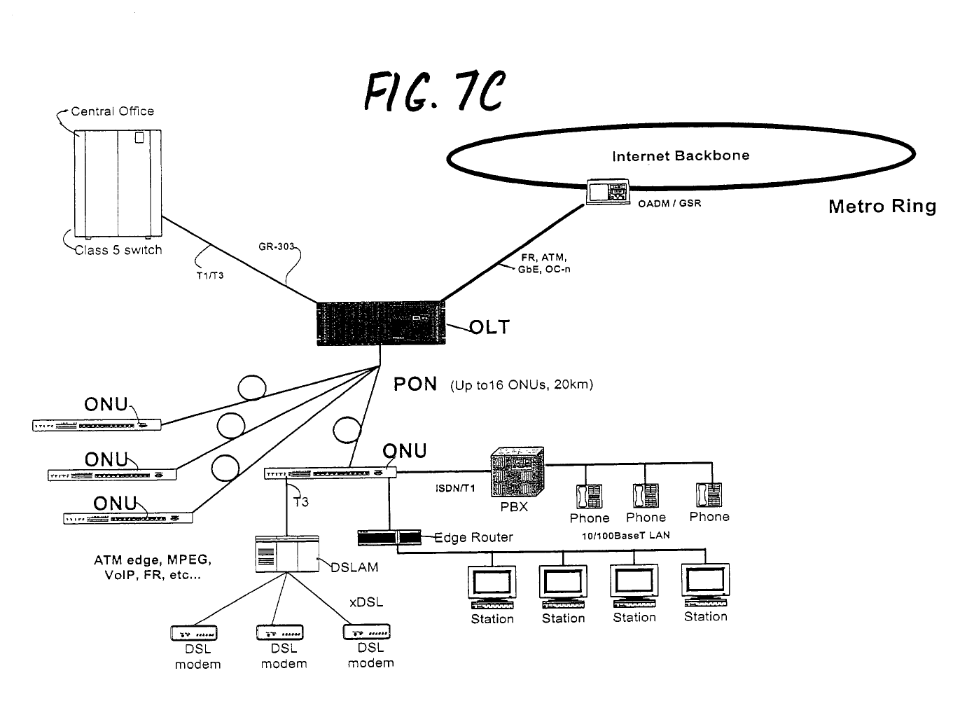

The logic illustrated in FIGS. 5D and 6D for the OLT is implemented, in some embodiments, in a field programmable gate array (FPGA) 701 that also performs other functions, such as MAC (for the PON) and ranging (on the PON) as illustrated in FIG. 7A. In addition to the just-described FPGA, the OLT also includes a network processor 702, such as NP3400 that is connected to the FPGA by a bus. The network processor 702 in turn is connected via a gigabit Ethernet PHY device 703 to the Ethernet. The FPGA 701 is also connected by a TDM bus (via a signal connector) to a DS3 line card (not shown) that grooms a number of T1 signals (e.g. 128 T1 signals) into a T3 or other higher rate link. The OLT further includes an optical module 704 coupled to the FPGA 701 to provide a connection to the ONUs in the PON. The OLT also includes a CPU 705 that is used for initialization and OAMP.

Similarly, the logic illustrated in FIGS. 5E and 6C is implemented in a number of FPGAs (or ASICs) that are included in a corresponding number of ONUs, as illustrated in FIG. 7B. To illustrate the correspondence and similarity, many reference numerals that are used in FIG. 7B are obtained by adding 50 to the corresponding reference numerals in FIG. 7A. The above-described OLT and a number of ONUs can be used to form the PON illustrated in FIG. 7C.

In one specific implementation, the major components on the OLT are:

FPGA . . . Xilinx Vertex II (XC2V1000)

Network processor . . . AMCC NP3400

GE Phy . . . Vitesse (VCS7135QN) and

PicoLight (PL-XSL-00-S13-03)

Microprocessor . . . Motorola (MPC8260)

And on the DS3 line card are:

Framer . . . PMC Sierra's TEMUX-84 (PM8316-PICP)

LIU . . . Conexant's (CX28333EXF)

Moreover, in this implementation, the major components on the ONU are:

FPAG . . . Xilinx Vertex II (XC2V1000)

Network processor . . . AMCC's NP3400

Micro Processor . . . Motorola (MPC860)

T1/E1 Framer+LIUs . . . Infineon (PEB22554HT-V1.3)

A passive optical networking system in some embodiments has fiber connections from a central office of a telephony service provider to a plurality of remote units which in turn connect to subscriber units. The downstream proceeds in a first stream on a dynamic time-division multiplex basis and is broadcasting in nature. The upstream from the remote units proceeds in accordance with a TDMA method. Both streams' transmission convergence (TC) and physical layers permit the Ethernet frames appearing on both ingress and egress directions to remain in their native format. The TC layer also provide access for TDM narrowband services, system related OAM, control signaling, and PHY link management.

In such embodiments, the high cost and complexity of previously proposed PON based communication systems is significantly reduced by simple time division multiplexed transport channels by which an Optical Line Termination (OLT) with an integrated multi-service switch router in central office site is connected to a plurality of remote Optical Network Units (ONU) with subscriber interfaces by means of a single strain optical fiber. Specifically, Internet Protocol (IP) packets aggregate through these optical interconnects between OLT and ONUs as native, standard Ethernet frames.

The TC layer structure is designed in a TDM framing logic with fixed or variable frame lengths (for TDM traffic and packet-based traffic respectively). Link and system level management OAMs are included as overheads in the framing. This frame allows other TDM based protocols to be transmitted within the same flow. The standard Ethernet frames are also carried in the same frame. The system synchronization is achieved by continuous downstream framing. The physical coding layer uses the Ethernet standard 8B/10B encoding scheme.

Therefore, in certain embodiments, passive optical networking systems transport integrated native Ethernet frames and TDM narrowband services. Such integrated services digital transport systems utilizing PON devices as optical splitter and combiner are basically suitable for IP packet and narrowband TDM services. Such embodiments eliminate the need for a dedicated transmission convergence (TC) layer to provide access for different services as required by some prior art PONs. This type of prior art TC requires usually multi-layer protocol translations and, hence, demands complicated design and implementation.

Numerous modifications and adaptations of the embodiments, examples and implementations described herein will be apparent to the skilled artisan.

Although in several embodiments of the type described above, an Ethernet frame is not segmented across a boundary between time slots, in other embodiments, segmentation may be done at least in the downstream direction. For example, To allow bandwidth efficient transmission, a simple segmentation and re-assemble (SAR) method may be used in some embodiments to transmit partial Ethernet frames separated by two TDM frames.

Furthermore, a telephony interface that is included in an ONU can be any number of 64 kbps channels supporting POTS lines or ISDN lines, instead of just T1/E1 lines.

Examples of alternative duration of subframes that may be used in the manner described herein include, half, or quarter or ⅛^{th}, or 1/32^{nd} of the 125 microsecond subframe described herein. Other embodiments can also provide variable length Ethernet subframes between any two TDM subframes.

Numerous such modifications and adaptations of the embodiments described herein are encompassed by the attached claims.

The descriptions in the following addendums A and B about a specific implementation of an OLT and an ONU respectively are meant to be illustrative of the invention.

### Addendum A

Following is a description of a hardware design for a field programmable gate array for an Optical Line Terminal line card (OLC). It is intended to provide essential yet complete information for hardware and software design. Following abbreviations are used herein.

| | |
|---|---|
| CAM | Content Addressable Memory |
| DS1 | Digital Signal Level 1 |
| FE | Fast Ethernet |
| GE | Gigabit Ethernet |
| IP | Internet Protocol |
| MAC | Media Access Control |
| MM | Multi Mode |
| OAM&P | Operation, Administration, Maintenance and Provisioning |
| ONU | Optical Network Unit |
| OLC | Optical Line Card |
| OLT | Optical Line Terminal |
| PON | Passive Optical Network |
| SONET | Sync Optical NETwork |
| TDM | Time Division Multiplexing |

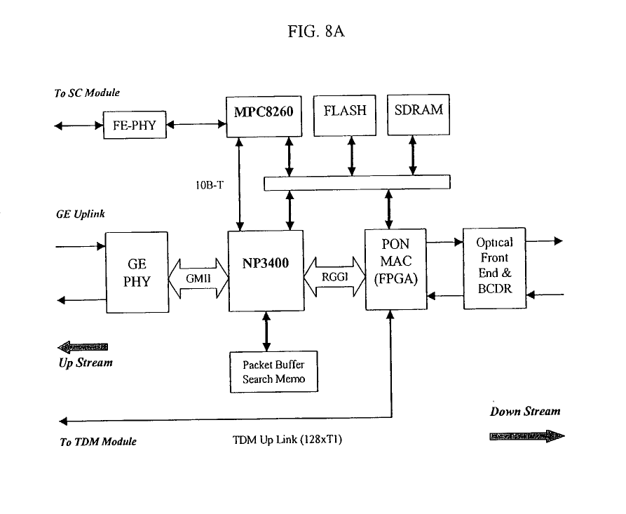

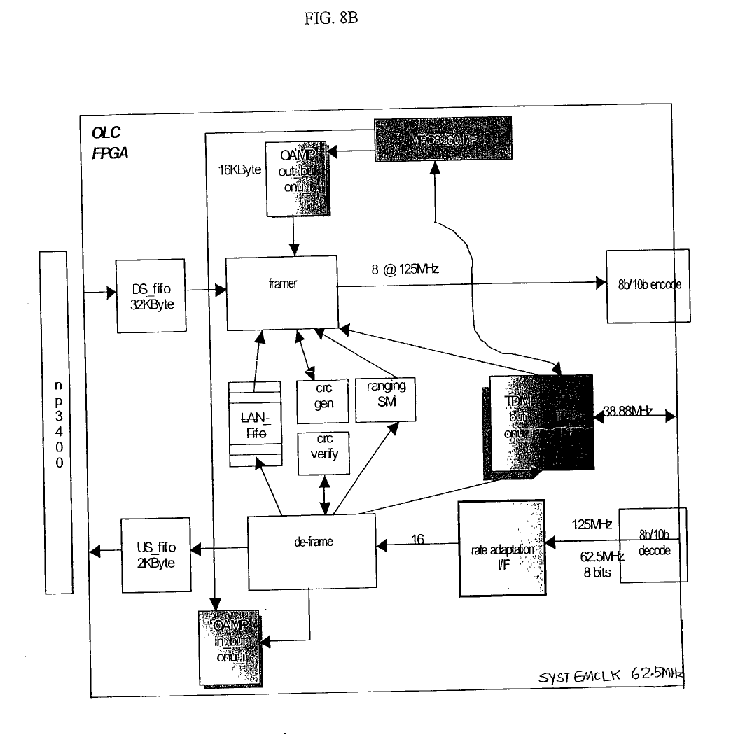

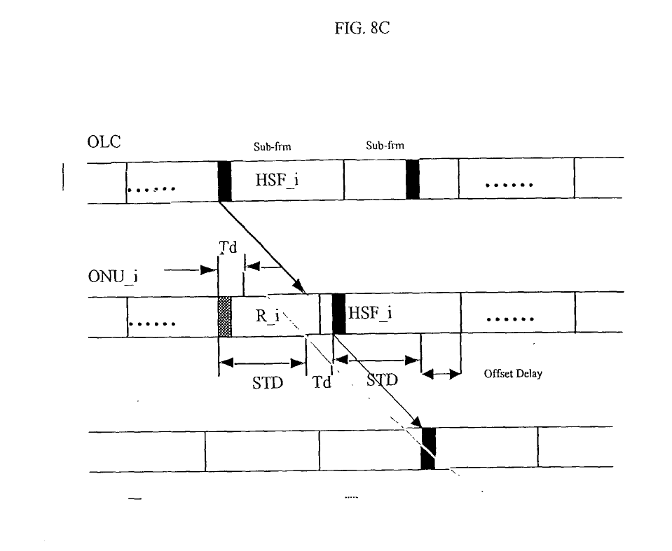

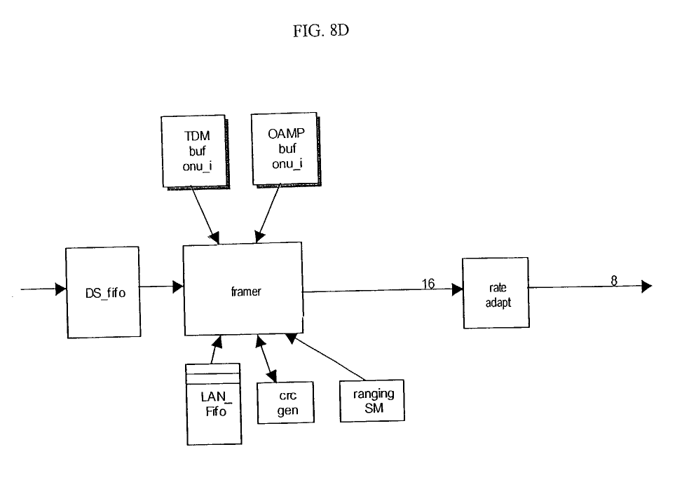

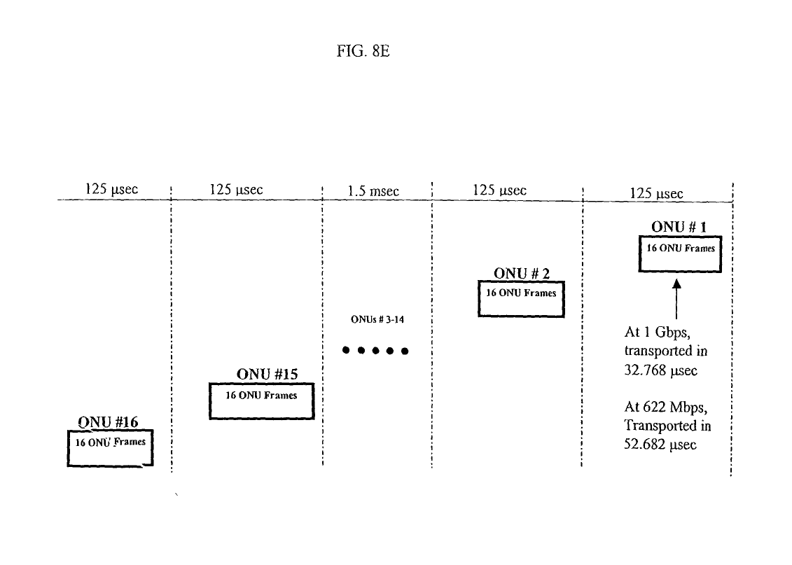

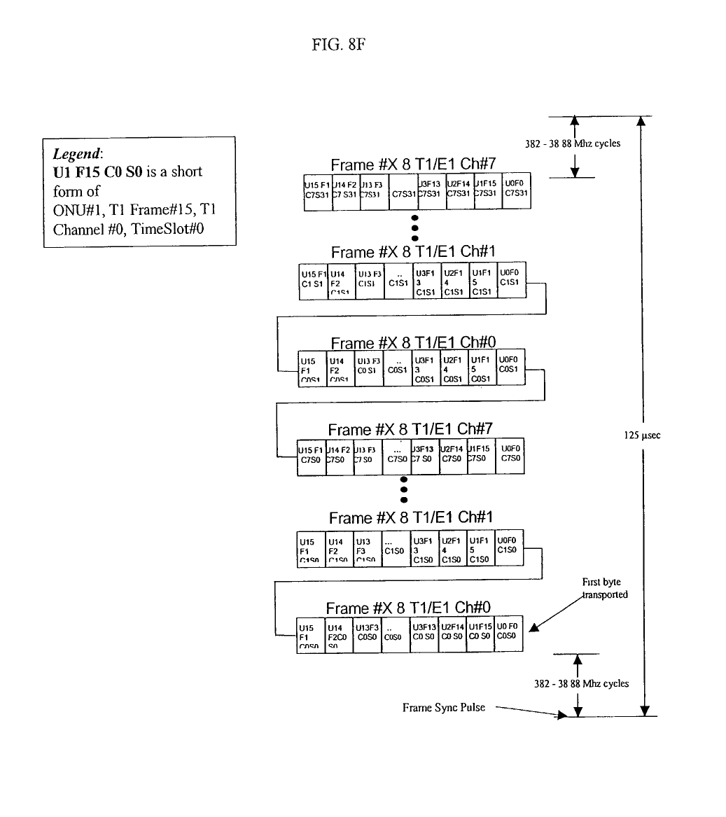

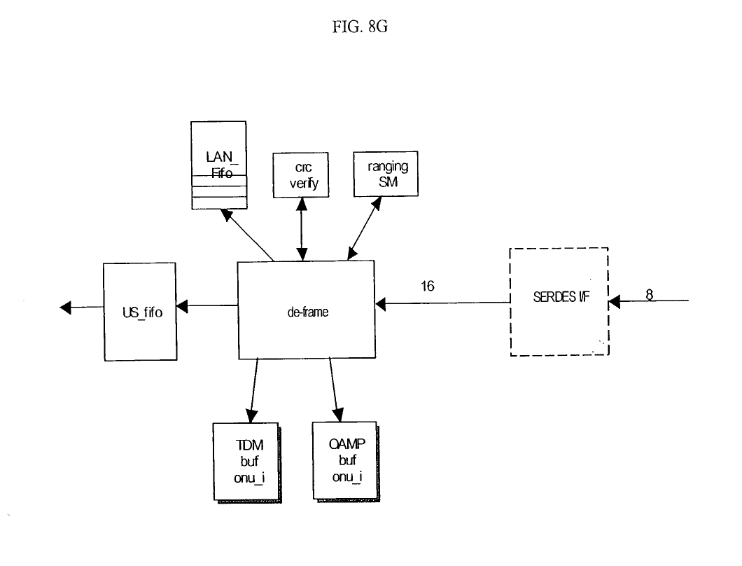

OLT is Central Office equipment that accesses the metro ring and Internet backbone via a Gigabit Ethernet connection. It also provides Gigabit Ethernet PON link to CPE or ONU. Both OLC and ONU are built around the MMC's np3400 network processor. See FIG. 8A for OLC Module Implementation System Block Diagram.

| | Base | TA_N | | port | |
|---|---|---|---|---|---|
| | address | wait | chip | size | |
| Component | (external) | states | select | (bits) | R/W |
| DRAM Bank 1 | 0x000 0000 | | CS2 | 32 | R/W |
| DRAM Bank 2 | 0x040 0000 | | CS3 | 32 | R/W |
| Internal RAM | 0x220 0000 | | | 32 | R/W |
| Flash Bank 1 | 0x280 0000 | | CS0 | 32 | R/W |
| Flash Bank 2 | 0x210 0000 | | CS1 | 32 | R/W |
| nP3400 | 0x300 0000 | | CS7 | 16 | R/W |
| FPGA | 0x400 0000 | | CS6 | 16 | R/W |

Refer to FIG. 7A for a top view of the OLC module board. System Capabilities are as follows:

24 Fast Ethernet+2 Gigabit Ethernet ports

Support up to 16 ONU's and 8 TLC's cards

Supports a dedicated CPU port for management and control.

Provides a standard SMII interface for each Fast Ethernet connection and an 8B/10B interface for each Gigabit Ethernet connection.

Supports from 384KB to 12MB of Packet Buffer Memory per nP3400 device. This Packet Buffer is dynamically allocated across all the ports.

Supports up to 16MB of routing table memory Packet size: 48 bytes to 16KB-1

On-chip Packet Classification CAM (Policy Engine) and interface for nPC2110 XSM External Search Machine (external search co-processor)

Referring to FIG. 7A, a XLNX XC2V1000 FPGA is used to enable a connection between NP3400 and PON PHY. As an extension of Gigabit Ethernet MAC, the FPGA performs synchronization, OAM&P, framing and de-framing functions.

Refer to FIG. 8B for a block diagram of the FPGA 701 (FIG. 7A). This FPGA provides the following capabilities:

Support up to 16 OAM&P message queue for downstream and another 16 queue for the upstream. (max 80 Byte each)

Support up to 128 T1/E1 streams and aggregate it into 8 bit 38.88 MHz TLC interface bus.

Support slave mode PowerPC bus mode

Assemble HSF and non-diagonal sub-frames from data buffer and TDM buffers.

Generate range request and process ranging information from ONUs

Statistical counters (detail is in the register map section below)

PON system bandwidth allocation and monitoring

PON system error monitoring and alarm generation

Referring to FIG. 5C, functions related to the frame structure are as follows:

For down-stream, diagonal sub-frames, or call header sub-frame (HSF) carry individual ONU specific data. The remaining segments in an HSF and all off-diagonal sub-frames are either broadcasting/multicasting, statistically shared by ONUs.

Down-stream is broadcasting in nature. A particular ONU picks its own OAM&P, signaling, etc. from its diagonal Sub-frame.

For up-streams, each ONU is assigned a particular HSF to transmit its own OAM&P, signaling, etc. The remaining HSF can be used to carry user data.

In up-stream, all off-diagonal sub-frames are assigned to individual ONUs according to bandwidth allocation at the time. Bandwidth allocation can be changed dynamically, but may not be in a real-time manner.

In order to support TDM tunneling, sub-frames should be assigned to an ONU in a more regular pattern to maintain constant jitter.

Total frame length is 7776 words long.

Downstream Header Subframe (HSF) format is as follows.

| | Number of | | |
|---|---|---|---|
| Description | bytes | Bit_0 | bit_15 |
| Frame delimiters | 2 | Comma_0 (K28.0) | Comma_1(K28.0) |
| Frame ID and TYPE | 2 | HSF frame type | ColumnNum rowNum |
| Ranging ID | 2 | Ranging type | Ranging State and Onu ID |
| | | (msg, noMsg) | |
| Ranging Message | 10 | Ranging byte0 | Ranging byte 1 |
| | | Ranging byte(n-2) | Ranging byte(n-1) |
| TDM Header | 2 | K30.7 | K30.7 |
| TDM ID (header 2) | 2 | TDM ID (8bit) | Active T1 map (8bit) |
| TDM Data | n*512 | TDM data byte (512*n) | TDM data byte (512*n) |
| TDM Data | n*512 | TDM data byte (512*n) | . . . |
| TDM data BIP (WIP) | | BIP16 | BIP16 |
| OAM Header | 2 | K27.7 | K27.7 |
| OAM Header 2 | 2 | ONU_i OAM type | length |
| ONU_specific HW | 80 | ONU_i HW_{—} | ONU_i HW_OAMP byte 1 |
| OAM/P | | OAMP byte0 | |
| | | . . . | . . . |
| | | ONU_i HW_{—} | ONU_i HW_OAMP byte79 |
| | | OAMP byte78 | |
| CRC16 on OAM msg | 2 | ONU_i OAMP CRC16_0 | ONU_i OAMP CRC16_1 |
| (optional) | | | |
| Ether Frame Header | 2 | K23.7 | K23.7 |
| Ethernet Frame Header 2 | 2 | Ethernet ID | Ethernet length (10 bit) |
| User Ethernet data frame1 | Variable | Ethernet data frame | Ethernet data (word aligned) |
| Ethernet frame trailer | 2 | CRC 16 | CRC 16 |
| Ether Frame Header | 2 | K23.7 | K23.7 |
| Ethernet Frame Header 2 | 2 | Ethernet ID | Ethernet length (10 bit) |
| User Ethernet data frame2 | Variable | Ethernet data frame | Ethernet data (word aligned) |
| Ethernet frame trailer | 2 | CRC 16 | CRC16 |
| . . . more Etherdata frames | | | |
| Unused | <1500 Bytes | Idle (K28.5) | K28.5 |

Format of downstream subframes that are not HSF (e.g. off-diagonal sub-frame) is as follows.

| | Number of | | |
|---|---|---|---|
| Description | bytes | Bit_0 | bit_15 |
| Frame delimiters | 2 | Comma_0 (K28.0) | Comma_1(K28.0) |
| Frame ID and TYPE | 2 | Non-HSF frame type | ColumnNum rowNum |
| Ranging ID | 2 | Ranging type (msg, noMsg) | Ranging State and Onu_ID |
| Ranging Message | 10 | Ranging byte0 | Ranging byte 1 |
| | | Ranging byte(n-2) | Ranging byte(n-1) |
| TDM Header | 2 | K30.7 | K30.7 |
| TDM ID (header 2) | 2 | TDM ID (8bit) | Active T1 map (8bit) |
| TDM Data | n*512 | TDM data byte (512*n) | TDM data byte (512*n) |
| TDM Data | n*512 | TDM data byte (512*n) | . . . |
| TDM data BIP (WIP) | | BIP16 | BIP16 |
| Ether Frame Header | 2 | K23.7 | K23.7 |
| Ethernet Frame Header 2 | 2 | Ethernet ID | Ethernet length (10 bit) |
| User Ethernet data frame 1 | Variable | Ethernet data frame | Ethernet data (word aligned) |
| Ethernet frame trailer | 2 | CRC16 | CRC16 |
| Ether Frame Header | 2 | K23.7 | K23.7 |
| Ethernet Frame Header 2 | 2 | Ethernet ID | Ethernet length (10 bit) |
| User Ethernet data frame2 | Variable | Ethernet data frame | Ethernet data (word aligned) |
| Ethernet frame trailer | 2 | CRC16 | CRC16 |
| . . . more Etherdata frames | | | |
| Unused | <1500 Bytes | Idle (K28.5) | K28.5 |

Upstream Header Subframe (HSF) format is as follows.

| | Number of | | |
|---|---|---|---|
| Description | bytes | Bit_0 | bit_15 |
| Guard time | 20 | 0x5555 | |
| | | (programmable) | |
| alignment | 32 | K28.5 | K28.5 |
| Preamble | 2 | K28.4 | K28.4 |
| Frame delimiters | 2 | Comma_0 (K28.0) | Comma_1 (K28.0) |
| Frame ID and TYPE | 2 | HSF frame type | ColumnNum rowNum |
| Ranging ID | 2 | Ranging type (msg, noMsg) | Ranging State and Onu_ID |
| Ranging Message | 6 | Ranging byte0 | Ranging byte1 |
| | | Ranging byte(n-2) | Ranging byte(n-1) |
| TDM Header | 2 | K30.7 | K30.7 |
| TDM ID (header 2) | 2 | TDM ID (8bit) | Active T1 map (8bit) |
| TDM Data | n*512 | TDM data byte (512*n) | TDM data byte (512*n) |
| 1DM data BIP (WIP) | | BIP16 | BIP16 |
| OAM Header | 2 | K27.7 | K27.7 |
| OAM Header 2 | 2 | ONU_i OAM type | length |
| ONU_i HW OAM/P | 80 | ONU_i HW_OAMP byte0 | ONU_i HW_OAMP byte1 |
| Ether Frame Header | 2 | K23.7 | K23.7 |
| Ethernet Frame Header 2 | 2 | Ethernet ID | Ethernet length (10 bit) |
| User Ethernet data frame1 | Variable | Ethernet data frame | Ethernet data (word aligned) |
| Ethernet frame trailer | 2 | CRC16 | CRC16 |
| Ether Frame Header | 2 | K23.7 | K23.7 |
| Ethernet Frame Header 2 | 2 | Ethernet ID | Ethernet length (10 bit) |
| User Ethernet data frame1 | Variable | Ethernet data frame | Ethernet data (word aligned) |
| Ethernet frame trailer | 2 | CRC16 | CRC16 |
| . . . more Etherdata frames | | | |
| Unused | <1500 Bytes | Idle (K28.5) | K28.5 |

Format of upstream subframes that are not HSF (e.g. off-diagonal sub-frame) is as follows.

| | Number of | | |
|---|---|---|---|
| Description | bytes | Bit_0 | bit_15 |
| Guard time | 20 | 0x5555 (programmable) | |
| alignment | 32 | K28.5 | K28.5 |
| Preamble | 2 | K28.4 | K28.4 |
| Frame delimiters | 2 | Comma_0 (K28.0) | Comma_1 (K28.0) |
| Frame ID and TYPE | 2 | SF frame type | ColumnNum rowNum |
| Ranging ID | 2 | Ranging type (msg, noMsg) | Ranging State and Onu_ID |
| Ranging Message | 6 | Ranging byte0 | Ranging byte1 |
| | | Ranging byte(n-2) | Ranging byte(n-1) |
| TDM Header | 2 | K30.7 | K30.7 |
| TDM ID (header 2) | 2 | TDM ID (8bit) | Active T1 map (8bit) |
| TDM Data | n*512 | TDM data byte (512*n) | TDM data byte (512*n) |
| TDM data BIP (WIP) | | BIP16 | BIP16 |
| Ether Frame Header | 2 | K23.7 | K23.7 |
| Ethernet Frame Header 2 | 2 | EthernetID | Ethernet length (10 bit) |
| User Ethernet data frame1 | Variable | Ethernet data frame | Ethernet data (word aligned) |
| Ethernet frame trailer | 2 | CRC16 | CRC16 |
| Ether Frame Header | 2 | K23.7 | K23.7 |
| Ethernet Frame Header 2 | 2 | Ethernet ID | Ethernet length (10 bit) |
| User Ethernet data frame1 | Variable | Ethernet data frame | Ethernet data (word aligned) |
| Ethernet frame trailer | 2 | CRC16 | CRC16 |
| . . . more Etherdata frames | | | |
| Unused | <1500 Bytes | Idle (K28.5/ D5.6) | |

Ranging and Synchronization is done as follows. The OLC transmit clock is the master clock for the PON system. It uses a local counter running the TXCLK rate to keep track of the time slot positions, in other words, sub-frame and supper-frame positions. The down stream ranging frame has 11 bytes. The up stream ranging frame has 7 bytes as shown in the following tables.

### Down Stream Ranging Frame Format

| Range ID | OLC ID | Offset | OLC Mac address |
|---|---|---|---|
| Range msg type | 4′h0 | Offset[15:0] | 6 bytes |
| (8bits) | OLC ID | | |
| ONU ID (5 bits) | Offset [22:16] | | |
| Range state (2 bit) | | | |
| Update (1 bit) | | | |

### Up Stream Ranging Frame Format

| Range ID | ONU Mac address |
|---|---|
| Range msg type (8bits) | 6 bytes |
| ONU ID (5 bits) | |
| Range state (2 bit) | |
| Update (1 bit) | |

FIG. 8C illustrates a 2-step ranging process for ONU_i. Since the constant delay time (200 us) is larger than the time it takes to transmit one sub-frame (125 us), 2 consective sub-frames will be used to range one ONU. The down- and up-stream frame structures should be aligned with a fixed time difference of exact two(2) sub-frame duration (250uS). In order to range ONU_i (i is not equal to 0), sub_frames i−1 (marked by R_i) and i in the ith frame of the up stream super frame will be used for the initial ranging. When the ONU_i receives the ranging frame from OLC, it will dealy Td before send back the reply frame. The reason for introducing this dealy is that in the case when the (i−1)th ONU is carrying TDM traffic and ONU_i has very short distance to OLC, collision may happen if the ONU_i sends back the ranging frame in the up stream direction immediately. Td shall be long enough to allow the pervious ONU to finish TDM transmission and less than 50 us to make sure the ranging process do not use more than 2 sub-frames. The OLC shall deduct Td from the round trip delay when calculating the offset delay. In the ranging monitoring state of ONU_i, the R_i sub_frame and unused bandwidth by ranging and OAM in HSF_i (except for HSF_15) shall be assinged to ONU_i for its data transmission.

For the ONU_0, its pervious sub_frame will be the 15^{th} sub_frame of the 15^{th} frame in the previous up stream super frame which is used by the ONU_15 for its ranging process. We shall enfore the following ranging rule to resolve this issue. The ranging will be done every other super frame. ONUs with even numbers will be ranged in one super frame and ONUs with odd numbers will be ranged in another super frame.

The ranging process starts when the OLT sends the ranging frame in sub-frame HSF_i to ONU_i in the down stream direction; it takes a single trip delay (STD) time to arrive ONU_i. If the ONU_i is not installed, there is no ranging information send back. Otherwise, if the ONU_i is there and receives the ranging frame, it sends a ranging frame back to the OLT after taking the delay (Td). The responding frame takes another STD to reach the OLT. Based on the above discussion, there should not be any collision for this up stream ranging frame to reach the OLT. The OLT then processes this ranging frame, calculates the actual round trip delay between OLT and ONU_i, compare it to ranging constant 200 us and get the difference. The difference will be called Offset Delay. The OLT will include the Offset Delay in the next ranging frame to ONU_i. The ONU_i, after receiving the offset_delay value, delays additional offset_delay amount on top of 50 us. The ranging process continues in this fashion until the received sub-frames are aligned with the Tx frame within an acceptable range (decided by the guard band bits). At this time, the OLT FPGA will change ranging state bits to inform the ONU_i to start up stream data and voice transmission. After the ONU_i has been ranged, the above ranging process continues and monitors whether the Offset Delay exceed the acceptable range.

Acts that the FPGA in the OLT performs in the ranging process are as follows:

1. Set offset delay to zero, send the ranging request with out-of-range status at the sub-frame prior to the diagonal sub-frame for a specific ONU_I;

2. Expect the ranging reply from ONU_I;

3. If the ranging reply arrives before the end of the next sub-frame, i.e. the diagonal sub-frame, calculate the time count from the moment the reply arrives to the end of the diagonal sub-frame. Got to 4. else ONU_I is not there or too far away.

4. If the status is out-of-range, The count is the offset delay value; else if the status is ranged, the count should be equal to the offset delay value, compare the value difference against the out-of-range threshold.

5. Wait till the same diagonal sub-frame time slot in the next supper-frame, assemble a ranging request frame with the offset delay value and ranged status in the request.

6. go to step 2.

Acts that an FPGA in the ONU_performs in the ranging process and synchronizing with OLT are as follows:

1. Continuely look for the COMMA_0 and COMMA_1 code groups. Once they are found, reset the RX counter. The RX counter counts for the 125 us time slot. Look for the HSF with an ID of ONU_I_I. (NOTE: The ONU ID value are set through a on-board DIP switch. The factory DIP setting should be hex FF, which is an in-valid value, a craftman will set the DIP to a valid value.)

2. Once its HSF is found, buffer the 11 range request bytes and verify its CRC, delay 50 us+the delay offset value, start/reset the TX counter, assemble an up-stream range frame, with the same status from OLT, and send it up-stream.

3. go to step 1.

NOTE: the TX counter is based on the recovered down-stream clock, (loop timing mode);

Hardware OAM&P message format is as follows. The level 2 OAM&P messages are grouped into the following 3 types as below.

1. L2 Performance Management Messages.

2. L2 Fault Management Messages and

3. L2 Configuration Management Messages.

The general format of hardware OAM&P message is as follows.

| | | | Command specific attributes | |
|---|---|---|---|---|
| Message group and ID | | Length | (more than 1 byte) | Crc 8 |
| Group (2 | Command (6 | 8 bit | Variable | 8 |
| bit) | bit) | | | |

Following is a list of OAM&P commands:

| | | | | Attributes |
|---|---|---|---|---|
| Group | | | | (its size |
| (2bit) | Description | Command | Length | in bytes) |
| 00 | No OAM&P | | | |
| | message | | | |
| 01 | PM: | Loop-back message | 2 | Correlation Tag (2) |
| | Performance | 6′h01: loopback request | | |
| | management | 6′h02: loopback reply | | |
| | message | | | |
| 10 | FM: Fault | Status Report: | 8 | APS: (4) |
| | management | bit 5: header CRC error | | RSVD: (4) |
| | message | bit 4: data framer CRC | | |
| | | error | | |
| | | bit 3: TDM BIP error | | |
| | | bit 2: Loss of Frame (LOP) | | |
| | | bit 1: RDI | | |
| | | bit 0: Loss of Signal (LOS) | | |
| 11 | CM: | 6′h20: provisional BW | 33 | Sequence No.: (1) |
| | Configuration | allocation request | | Bit map: (32) |
| | management | 6′h21: provisional BW | 33 | Sequence No.: (1) |
| | message | modification request | | Bit map: (32) |
| | | 6′h22: BW audit request | 1 | Sequence No.: (1) |
| | First 2 bit of | 6′h33: provisional BW | 33 | Sequence No. + |
| | command: | allocation/modification reply | | Status (1); 0 - |
| | To ONU: 2 | | | success; 1 - failure |
| | To OLT: 3 | | | Bit map: (32) |
| | | 6′h34: BW audit reply | 33 | Sequence No. + |
| | | | | Status (1); 0 - |
| | | | | success, 1 - failure |
| | | | | Bit map: (32) |
| | | 6′h35: Dynamic BW allocation | 3 | Sequence Num: 1 |
| | | request | | No. of timeslots: 1 |
| | | | | No. of frames: 1 |
| | | 6′h25: Dynamic BW full grant | 33 | Sequence No.: (1) |
| | | | | Bit map: (32) |
| | | 6′h26: Dynamic BW partial | 33 | Sequence No.: (1) |
| | | grant | | Bit map: (32) |
| | | 6′h25: Dynamic BW grand | 33 | Sequence No.: (1) |
| | | failure | | Bit map: (32) |

OLC is the master in bandwidth allocation process. OLC keeps 16 copies of 256-bit map in FPGA registers. One bit map is for an ONU on the PON network, each bit in the map represents one timeslot in the super-frame structure. OLC software is responsible to initiate bandwidth allocation or modification. Software needs to make sure that the timeslot bits in a bitmap evenly distributed. FPGA only pass the bitmap information to the individual ONU. It does not verify the consistence of the timeslot distribution for all ONUs on the PON.

Refer to FIG. 8D for a downstream block diagram of the OLC.

| | | Destination | Source | Type/ | | |
|---|---|---|---|---|---|---|
| Preamble | SFD | Address | Address | Length | Data | FCS |
| 7 | 1 | 6 | 6 | 2 | 46 . . . 1500 | 4 |

### MAC Frame Format

The sequence of actions in framer block

1. Start the TX counter and keep track of the time slots;

2. Insert and send common header bytes for both diagonal and non-diagonal sub-frames. IF this is a diagonal sub-frame, GO TO 3; ELSE IF this is a non-diagonal sub-frame, GO TO 5.

3. Assemble the diagonal sub-frame with ranging requests.

4. Insert HW OAM&P frame. HW OAM&P frame format is described elsewhere;

5. Insert TDM data; TDM data are read from one TDM buffer and append TDM channel ID and BIP8.

6. If the OAM&P message buffer is enabled, insert OAM&P message MAC frame. Software is supposed to write the OAM&P messages into an ONU-specific buffer and set ONU_I_msg_rdy bit. FPGA sees the ONU_I_msg_rdy bit is set, it will build a MAC frame for the OAM&P message and clear the ONU I_msg_rdy bit after the frame is completed. The message length information needs to be conveyed by software through a registers or the first byte of the message.

7. If the layer2 bridging function is enabled, a scheduling algorithm will direct the Ethernet data from either from the non-empty DS FIFO or from LAN FIFO.

8. Keep track of the frame size and remaining time slot, if the next Ethernet data frame length exceed the remaining time slot window. Stop transfer data from the Ethernet FIFO; fill the remaining window with IDLE characters. The data frame length is located from at the fourth field of the MAC frame.

9. TX counter indicates the next time-slot boundary, repeat from 2, while proceed to 10

10. Depends on the SERDES interface, 10 bits or 20 bits. The output from frame assembling is 8 bits or 16 bits bus to feed to 8 b/10 b encoder logic.

NOTE:

1. The DS FIFO size is selected to be 16×32K.

2. The size of OAM&P message buffer is 256 bytes for each ONU.

3. Down-stream path registers including:

Down-stream PON frame counts

Down-stream (DS) Ethernet FIFO control and status: reset_fifo, fifo_empty, fifo_full, fifo_overrun.

DS FIFO high water mark register, if the threshold is exceeded, the TXFULL signal is asserted to stop the data flow from NP3400.

Interrupt status register, fifo_overrun, ranging complete

Downstream TDM Data Flow and Format is as follows.

NOTE: F0-C1-S3 is short form of “T1 Frame #0, T1 Channel #1, and Time Slot #3”. The range of the subscript is F0˜F15; C0˜C7; S0˜S31;

TDM data format from ONU [I]

| | | |
|---|---|---|
| F0-C0-S0 | | |
| F0-C1-S0 | | |
| F0-C2-S0 | | |
| . . . | | |
| F0-C7-S0 | 8 | bytes |
| F0-C0-S1 | | |
| . . . | | |
| F0-C7-S1 | | |
| . . . | | |
| F0-C7-S31 | 8x32 | bytes |
| F1-C0-S0 | | |
| . . . | | |
| F2-C0-S0 | | |
| . . . | | |
| F15-C7-S31 | 16x8x32 | bytes |

### Buffer Data Format for TDM Data to/from ONU [I]

Format of TDM data in the buffer for ONU [I+1 ] is as follows.

| | | |
|---|---|---|
| F0-C0-S0 | | |
| F0-C1-S0 | | |
| F0-C2-S0 | | |
| . . . | | |
| F0-C7-S0 | 8 | bytes |
| F0-C0-S1 | | |
| . . . | | |
| F0-C7-S1 | | |
| . . . | | |
| F0-C7-S31 | 8x32 | bytes |
| F1-C0-S0 | | |
| . . . | | |
| F2-C0-S0 | | |
| . . . | | |
| F15-C7-S31 | 16x8x32 | bytes |

### Buffer Data Format for TDM Data to/from ONU [I+1]

Refer to FIG. 8E for an illustration of ONUs-OLC TDM subframe alignment. FIG. 8F illustrates OLC-TLC Data Time Line Representation.

TDM data format at OLC-TLC interface

TDM data format at OLC-TLC interface

| | |
|---|---|
| U0-F0-C0-S0 | Start of Frame after FS |
| U1-F15-C0-S0 | |
| U2-F14-C0-S0 | |
| U3-F13-C0-S0 | |
| U4-F12-C0-S0 | |
| U5-F11-C0-S0 | |
| U6-F10-C0-S0 | |
| U7-F9-C0-S0 | |
| U8-F8-C0-S0 | |
| U9-F7-C0-S0 | |
| U10-F6-C0-S0 | |
| U11-F5-C0-S0 | |
| U12-F4-C0-S0 | |
| U13-F3-C0-S0 | |
| U14-F2-C0-S0 | |
| U15-F1-C0-S0 | |
| U0-F0-C1-S0 | |
| U1-F15-C1-S0 | |
| . . . | |
| U15-F1-C1-S0 | |
| U0-F0-C2-S0 | |
| U1-F15-C2-S0 | |
| . . . | |
| U15-F1-C2-S0 | |
| . . . | |
| U0-F0-C0-S1 | |
| U1-F15-C0-S1 | |
| . . . | |
| U15-F1-C0-S1 | |
| . . . | |
| U0-F0-C7-S31 | |
| U1-F15-C7-S31 | |
| . . . | |
| U15-F1-C7-S31 | End of Frame before FS |
| U0-F1-C0-S0 | Start of Frame after FS |
| U1-F0-C0-S0 | |
| . . . | |
| U15-F2-C7-S31 | End of Frame before FS |

NOTE:
U0-F1-C2-S3 is short form of “ONU #0, T1 Frame #1, T1 Channel #2, Time Slot #3”. The range of the subscript is U0˜U15; F0˜F15; C0˜C7; S0˜S31;

### TDM Data Format at OLC-TLC Interface

### Sequence of actions in downstream TDM interface block

1. OLC TDM interface receives interleaved TDM data as depicted above. The time line diagram in FIG. 8F explains the timing between frame sync pulse the first byte of TDM data.

2. OLC extracts the interleaved TDM data and store them in 16 buffers; the data format in each buffer is depicted in above tables. Along the TDM data from TLC, there is an enable signal to indicate which T1/E1 stream are valid or provisioned. For the un-provisioned T1/E1, idle data is written to its time slot positions in the TDM data buffer.

3. Once the TDM transmitting opportunity comes, depending on the column number, OLC reads TDM data from the corresponding TDM data buffer and insert the data to the PON frame. This is the action 5. FIG. 8E shows the TDM bursts to each ONU in the PON network.

Up Stream Data Flow Design is as Follows.

The first logic block on the receiving path is SERDES interface block. It is different for Gigabit product and 125 Mbps demo product.

For a demo product, external SERDES chip is not used. The FPGA will have a serial data input and receiving clock. SERDES block will perform serial to parallel (20 bit) conversion. Receiving clock is 125 MHz. The internal clock is 62.5 MHz (for 20 bit data path).

For a gigabit product, external SERDES chip is used. The FPGA will convert the 10 bit or 20 bit interface data bus; If SERDES has a 10-bit interface, the 10-bit data bus is connected to the SERDES Interface Block. The output of this block goes to 8 b/10 b decoders, which decode the data into 16 bit wide data. If SERDES already has 20 bit interface, the FPGA interface logic is disabled. The 20 bit data bus is connected to the 8 b/10 b decoder block.

FIG. 8G illustrates a upstream block diagram for the OLT. The sequence of action in de-frame block

1. Once the external CRD device locks onto the data stream, de-frame block will get data from the 8 b/10 b decoder and monitor the K_OUT signal for the comma detection and look for frame_ID subsequently. If frame_ID found, start the RX counter, running at the RXCLK, (in demo board, it's 6.25 MHz; and giga bps is 62.5 MHz). If this is a diagonal sub-frame, go to 2; else if this is a non-diagonal sub-frame, go to 4.

2. Extract the 11 bytes of ranging information, check the ranging status and start/move in the ranging state machine as described herein.

3. Extract the hardware OAM&P messages; the length of this kind of message is carried in the OAM_ID word. The action after obtain the message is TBD.

4. Extract TDM data bytes, and store the TDM into the appropriate TDM buffer, if the BIP8 verification fails, the FIFO pointer should be backed up.

5. Extract the ONU_I specific OAM&P messages; After the OAM&P messages have been verified and completely written to the ONU_I specific message buffer, FPGA generates a service-level interrupt. The software is supposed to respond to the interrupt and check the interrupt status and pick up the messages from the corresponding buffer memory.

6. Extract the Ethernet data frame; write them to the up-stream FIFO. If the layer2 bridging function is enabled, the same Ethernet data frame will also be written to LAN FIFO. Meanwhile, monitor the RX counter and watch for the time slot boundary; If the IDLE patterns, ignore the idle data till the end of time slot.

7. FPGA needs to peek into the length field of the Ethernet frame in order to determine the beginning and the end of a frame. Appropriate “SOF” and “EOF” symbols are added to according to the RGGI interface requirements.

8. Go to 1.

The upstream FIFO size is selected to be 256 byte or 128 words long. It monitors the RXFULL signal from nP3400, Ethernet data transfer takes place whenever the FIFO is non-empty and the nP3400 is not full.

NOTE:

Up-stream path registers including:

Up-stream PON frame counts

Up-stream (US) Ethernet FIFO control and status: reset_fifo, fifo_empty, fifo_full, fifo_underrun.

RX FIFO low water mark register, if the threshold is exceeded, the FIFO is considered empty.

Control register for enabling bridging (layer2) functions.

Interrupt status register, us_fifo underrun,

### Upstream TDM Data Flow

### Sequence of Actions in Upstream TDM Interface Block

1. Branching from action 4, OLC extracts the TDM data from the PON frame and stores them to the column depended TDM buffer. The column number is synchronized after the ranging process is successful. The data format in each TDM buffer is shown above.

2. 382 TDM clock cycles after generating Frame Sync pulse, OLC reads the TDM data from upstream TDM data buffer 0 to 15 sequentially, and sends the data to TLC interface. The outgoing data format is shown in a table herein. Timing relationship of the outgoing data is illustrated in FIG. 8F.

3. OLC keeps track of the read and write pointers for the 16 TDM buffers, no data will be dropped. Note that no data valid signal is generated from OLC to TLC direction, TLC is supposed to know the provisioned T1/E1 slots.

The Various Interfaces to the FPGA in the OLC are as Follows.

NP3400 Interface: RGGI (nP3400 stack port) interface is used for its simplicity. The RGGI interface block handles the framing and flow control.

SERDES Interface: If the SERDES is 10 bit Gigabit Ethernet SERDES, like Vittese VSC7123, the receiving interface has 2 complementary half rated clock, Rxclk and RxclkN. The 10 bit data are latched at the alternating rising edge of clocks. The FPGA interface logic need to have a simple state machine to identify the state of receiving and leading data byte. The internal logic clock is the lagging clock; and internal data bus is 20 bits wide. If the SERDES is 20 bit Gigabit Ethernet SERDES, like AMCC S2046, the receiving interface has one 62.5MHz clock and the data bus is 20 bit wide. The 8 b/10 b decoding logic is after 10 bit to 20 bit conversion logic. The decoding logic is concatenating 2 8 b/10 b decoders. The running disparity of the first 10 bit data is used as disp_in for the second 10 bit data; the running disparity of second 10 bit is used as disp_in for the next 20 bit of data. MPC8260 Interface: MPC8260 local bus clock is 50 MHz. Data bus is 16 bit wide. Address bus is 28 bit wide. FPGA drives two interrupt lines. The interrupt lines are classified as exception-level and service-level interrupt. The exception-level interrupt has a higher priority. Exception-level: framer/CRC errors, FIFO errors, ranging drift out of range. Service-level: ranging completion, OAM&P message received.

TLC Interface on OLC Side: One OLC will aggregate up to 128 T1 streams. OLC FPGA extracts the interleaved TDM data bytes and writes them to an ONU specific TDM FIFO. Thus, there are 16 FIFOs and each FIFO is at least 32*8*8 deep and 32 bit wide in size. The actual implementation may use 32 bit s wide by 2048 deep FIFOs. The TDM interface generates a continuous 38.88 MHz byte stream to the TLC line card. If any of the 16 FIFO has at least one frame, the block reads from the 16 FIFOs or a fixed idle data pattern, in the case that corresponding FIFO has no frame. The 38.88 MHz byte stream is byte interleaved from the 16 FIFOs.

NOTE: If a T1 channel is not used, but its space is kept in the 16 TDM FIFO and also in the OLC-TLC stream.

External Memory Interface: External memory will be used for TDM buffering. One SRAM chip is used for both upstream and downstream TDM data buffering. The memory data interface is 32 bit s wide and the clock is 125 MHz for read and write operations.

OLT MAC FPGA uses Xilinx VirtexII, XC2V1000-4FF896C. It is a flip chip fine-pitch ball grid array package, with 432 user I/O pins. Pin Description: Total estimated pin count is 294. The total available user I/O pin in XC2V1000 is 324.

External Memory Modules: TDM queue buffer are provided from external memory. The size requirement calculation: for 1 ONU, 32×8×(16*2)=8192 bytes; full duplex is 16384 bytes; for 16 ONU's, the required bytes are 16×16384=262.144 Kbytes=2 Mbits

Therefore, the required dual port memory size is 2 M bits. SRAM selection is 58L128L32F. If only use one dual port memory chip, it needs to be shared between DS and US, the read and write clock frequency need to be greater than 125 MHz.

Clock Pin Assignment: Receiving SERDES output clock rxclk and rxclk_n of 62.5 (not 62.208) MHz. Microprocessor MPC8260 clock is 66 MHz. NP3400 clock npClk is 62.5 MHz; Transmitting SERDES clock txclk 125 MHz, this clock needs to be divided by 2 using a DLL and the resulting clock drives internal logic. TLC interface clocks, txclk and rxclk with a frequency of 38.88 MHz. 1 External memory clock of 125 MHz. Total 7 clocks and 1 DLL.

### Memory Map

| Block Name | Address Range |
|---|---|
| FPGA chip select (CS6) | 0x400 0000 |
| Down stream OAM&P message buffer | 0x400 0000-0x400 0FFF |
| (160x16) | |
| 16 message queues: | |
| ONU_0: 0x400 00xx | |
| ONU_1: 0x400 01xx | |
| ONU_2: 0x400 02xx | |
| . . . | |
| ONU_15: 0x400 0fxx | |
| Up stream OAM&P message buffer | 0x400 2000-0x400 3FFF |
| (160x16) | |
| Register address range | 0x400 4000-0x400 4FFF |
| DS FIFO Memory | 0x401 0000-0x401 FFFF |
| US FIFO Memory | 0x402 0000-0x402 FFFF |
| TDM DS FIFO memory | 0x400 6000-0x400 7FFF |
| TDM US FIFO memory | 0x400 8000-0x400 9FFF |

### Register Map

| Offset | | | Default | | |
|---|---|---|---|---|---|
| (Hex) | Name | Description | Value | Width | Operation |

OAM&P Registers

| | | | | | |
|---|---|---|---|---|---|
| 00 | ID | OLC ID, Version number | 0x0000 | 16 | RW |
| 02 | PGSZ | Number of guard band and pattern | 0x0008 | 16 | RW |
| 04 | EMPN | Number of preambles and pattern | 0xF055 | 16 | RW |
| 06 | BCR\| | Reset, functional controls | 0x0000 | 16 | RW |
| 08 | | Diagnostic control enables | | | |
| 0a | syslp | System loopback enables | 0x0000 | 16 | RW |
| 10 | | US disparity error count | | | |
| 1A | | Range enable | | | |
| 1C | | Burst CDR reset control | | | |
| 1E | afmsz | Speed,Auto frame size (32-800) | 0x080 | 10 | |
| 20 | UST0 | ONU_0 RX status | 0x0000 | 16 | R |
| 22 | UST1 | ONU_1 RX status | 0x0000 | 16 | R |
| 24 | UST2 | ONU_2 RX status | 0x0000 | 16 | R |
| 26 | UST3 | ONU_3 RX status | 0x0000 | 16 | R |
| 28 | UST4 | ONU_4 RX status | 0x0000 | 16 | R |
| 2A | UST5 | ONU_5 RX status | 0x0000 | 16 | R |
| 2C | UST6 | ONU_6 RX status | 0x0000 | 16 | R |
| 2E | UST7 | ONU_7 RX status | 0x0000 | 16 | R |
| 30 | UST8 | ONU_8 RX status | 0x0000 | 16 | R |
| 32 | UST9 | ONU_9 RX status | 0x0000 | 16 | R |
| 34 | UST10 | ONU_10 RX status | 0x0000 | 16 | R |
| 36 | UST11 | ONU_11 RX status | 0x0000 | 16 | R |
| 38 | UST12 | ONU_12 RX status | 0x0000 | 16 | R |
| 3A | UST13 | ONU_13 RX status | 0x0000 | 16 | R |
| 3C | UST14 | ONU_14 RX status | 0x0000 | 16 | R |
| 3E | UST15 | ONU_15 RX status | 0x0000 | 16 | R |
| 40 | DSBCS0 | DownStream OAM buffer 0 status | | 16 | RW |
| 42 | DSBCS1 | DownStream OAM buffer 1 status | | 16 | RW |
| 44 | DSBCS2 | DownStream OAM buffer 2 status | | 16 | RW |
| 46 | DSBCS3 | DownStream OAM buffer 3 status | | 16 | RW |
| 48 | DSBCS4 | DownStream OAM buffer 4 status | | 16 | RW |
| 4A | DSBCS5 | DownStream OAM buffer 5 status | | 16 | RW |
| 4C | DSBCS6 | DownStream OAM buffer 6 status | | 16 | RW |
| 4E | DSBCS7 | DownStream OAM buffer 7 status | | 16 | RW |
| 50 | DSBCS8 | DownStream OAM buffer 8 status | | 16 | RW |
| 52 | DSBCS9 | DownStream OAM buffer 9 status | | 16 | RW |
| 54 | DSBCS10 | DownStream OAM buffer 10 status | | 16 | RW |
| 56 | DSBCS11 | DownStream OAM buffer 11 status | | 16 | RW |
| 58 | DSBCS12 | DownStream OAM buffer 12 status | | 16 | RW |
| 5A | DSBCS13 | DownStream OAM buffer 13 status | | 16 | RW |
| 5C | DSBCS14 | DownStream OAM buffer 14 status | | 16 | RW |
| 5E | DSBCS15 | DownStream OAM buffer 15 status | | 16 | RW |
| 60 | BWC | BW allocation enable for 16 ONUs | 0x0000 | 16 | RW |
| 62 | BWS | BW allocation status for 16 ONUs | 0x0000 | 16 | R |
| 64 | | UpStream OAM buffer status | | 16 | R |
| 66 | UBRDP | Upstream buffer read pointer | 0x0000 | 16 | R |
| 68 | UBWRP | Upstream buffer write pointer | 0x0000 | 16 | R |
| 70 | TLS\| | TDM loop-back setup register | 0x0000 | 16 | RW |
| 80 | LPST0 | Loop-back status (ONU 3-0) | | 16 | R |
| 82 | LPST4 | Loop-back status (ONU 7-4) | | 16 | R |
| 84 | LPST8 | Loop-back status (ONU 11-8) | | 16 | R |
| 86 | LPST12 | Loop-back status (ONU 15-12) | | 16 | R |
| 88 | LPTAG | Loop-back tag value | 0xa26b | 16 | RW |
| 8a | LPC | Loop-back count | | | |
| 90-94 | OMA\| | OLC MAC address (MSB - LSB) | 0x0000 | 16 | RW |
| A0 | RSR | Ranging status register | 0x0000 | 16 | R |
| A2 | RFR | Ranging failed register | 0x0000 | 16 | R |
| A4 | ROFR | Ranging OA failed register | 0x0000 | 16 | R |
| A6 | RCR | Ranging command register | 0x0000 | 16 | RW |
| A8 | OARR | ONU auto request register | 0x0000 | 16 | R |
| C0˜DE | OSNC | ONU serial number check sum register | 0xffff | 16 | R |
| E0˜FE | OFFR | Offset register | 0x0000 | 16 | R |
| 100 | TDLB0 | ONU0 TDM channel enable | 0x0000 | 16 | R |
| 102 | TDLB1 | ONU1 TDM channel enable | 0x0000 | 16 | R |
| 104 | TDLB2 | ONU2 TDM channel enable | 0x0000 | 16 | R |
| 106 | TDLB3 | ONU3 TDM channel enable | 0x0000 | 16 | R |
| 108 | TDLB4 | ONU4 TDM channel enable | 0x0000 | 16 | R |
| 10a | TDLB5 | ONU5 TDM channel enable | 0x0000 | 16 | R |
| 10c | TDLB6 | ONU6 TDM channel enable | 0x0000 | 16 | R |
| 10e | TDLB7 | ONU7 TDM channel enable | 0x0000 | 16 | R |
| 110 | TDLB8 | ONU8 TDM channel enable | 0x0000 | 16 | R |
| 112 | TDLB9 | ONU9 TDM channel enable | 0x0000 | 16 | R |
| 114 | TDLB10 | ONU10 TDM channel enable | 0x0000 | 16 | R |
| 116 | TDLB11 | ONU11 TDM channel enable | 0x0000 | 16 | R |
| 118 | TDLB12 | ONU12 TDM channel enable | 0x0000 | 16 | R |
| 11a | TDLB13 | ONU13 TDM channel enable | 0x0000 | 16 | R |
| 11c | TDLB14 | ONU14 TDM channel enable | 0x0000 | 16 | R |
| 11e | TDLB15 | ONU15 TDM channel enable | 0x0000 | 16 | R |
| \| | | | | | |
| 122 | TSTS | TDM US status | | 16 | RCLEAR |
| 200-21E | BMP\| | BW allocation bitmap for up stream | 0x0001 | 16 | RW |

Down-stream Control and Status Registers

| | | | | | |
|---|---|---|---|---|---|
| 400 | DSFS | DS FIFO Status | | 16 | R |
| 402 | DSFC | DS FIFO high water mark | 0x0000 | 16 | RW |
| 404 | DFWP | DS FIFO write pointer | | 16 | R |
| 406 | DFRP | DS FIFO read pointer | | 16 | R |
| 440 | | SRAM test mode | 0x0000 | 16 | RW |
| 442 | | US test pattern | 0xC000 | 16 | RW |
| 444 | | DS test pattern (also used for mode 2) | 0xD000 | 16 | RW |
| 446 | | SRAM test status | | 16 | RCLEAR |
| 448 | | Sram test addresss | 0x0000 | 16 | RW |
| 44a | | Sram test data read back 1 | | | |
| 44c | | Sram test data read back 2 | | | |

Up-stream Control and Status Registers

| | | | | | |
|---|---|---|---|---|---|
| 480 | USFS | US FIFO Status | | 16 | R |
| 482 | USFC | US FIFO high water mark | 0x0000 | 16 | RW |
| 484 | UFWP | US FIFO write pointer | | 16 | R |
| 486 | UFRP | US FIFO read pointer | | 16 | R |
| 500 | | Counter command register | | | RW |
| 502 | | MSB of the counter value | | | RCLEAR |
| 504 | | LSB of the counter value | | | RCLEAR |

Exception Interrupt Registers

| | | | | | |
|---|---|---|---|---|---|
| 580 | EINTS | Exception interrupt status | 0x0000 | 16 | RCLEAR |
| 582 | EINTM | Exception interrupt mask | 0x0000 | 16 | RW |
| 590 | | Threshold for number of error frame | 0x0000 | 16 | RW |
| 600-7ff | | DS to-ONU multicast bitmap register | | | |

[image]

[image]

[image]

[image]

[image]

[image]

[image]

[image]

[image]

[image]

[image]

[image]

[image]

[image]

[image]

[image]

### Addendum B

Following is a description of a hardware design for a field programmable gate array for an Optical Network Unit (ONU). It is intended to provide essential yet complete information for hardware and software design. Following abbreviations are used herein.

| | |
|---|---|
| CAM | Content Addressable Memory |
| DS1 | Digital Signal Level 1 |
| FE | Fast Ethernet |
| GE | Gigabit Ethernet |
| IP | Internet Protocol |
| LAN | Local Area Network |
| MAC | Media Access Control |
| MM | Multi Mode |
| OAM&P | Operation, Administration, Maintenance |
| | and Provisioning |
| ONU | Optical Network Unit |
| OLC | Optical Line Card |
| OLT | Optical Line Terminal |
| PON | Passive Optical Network |
| SM | Single Mode |
| SONET | Sync Optical NETwork |
| TDM | Time Division Multiplexing |
| WAN | Wide Area Network |

Each ONU is Customer Premises Equipment that accesses the customer LAN networks via multiple Fast Ethernet connections and T1 connections. It also provides Gigabit/Fast Ethernet PON link to OLT, central office equipment. Both OLC and ONU are built around the MMC's nP3400 network processor.

| | | Memory | | |
|---|---|---|---|---|
| Com- | | Size | Chip | Port Size |
| ponent | Base Address | (Bytes) | Select | (Bits) |
| DRAM | 0x000 0000 | 16 M | CS2 | 32 |
| Bank 1 | | | | |
| DRAM | 0x040 0000 | 16 M | CS3 | 32 |
| Bank 2 | | | | |
| Internal | 0x220 0000 | | NA | 32 |
| RAM | | | | |
| Intel | 0x280 0000 | 16 M | CS0 | 32 |
| Flash | | | | |
| NP3400 | 0x300 0000 | | CS7 | 16 |
| FPGA | 0x400 0000 | | CS4 | 16 |
| Quad | TDM Mod1 0x500 0000 | | CS5 | 8 |
| Framers | TDM Mod1 LED 0x500 1000 | | | |
| | TDM Mod2 0x500 2000 | | | |
| | TDM Mod2 LED 0x500 3000 | | | |
| XSM | 0x600 0000 | | CS6 | 16 |

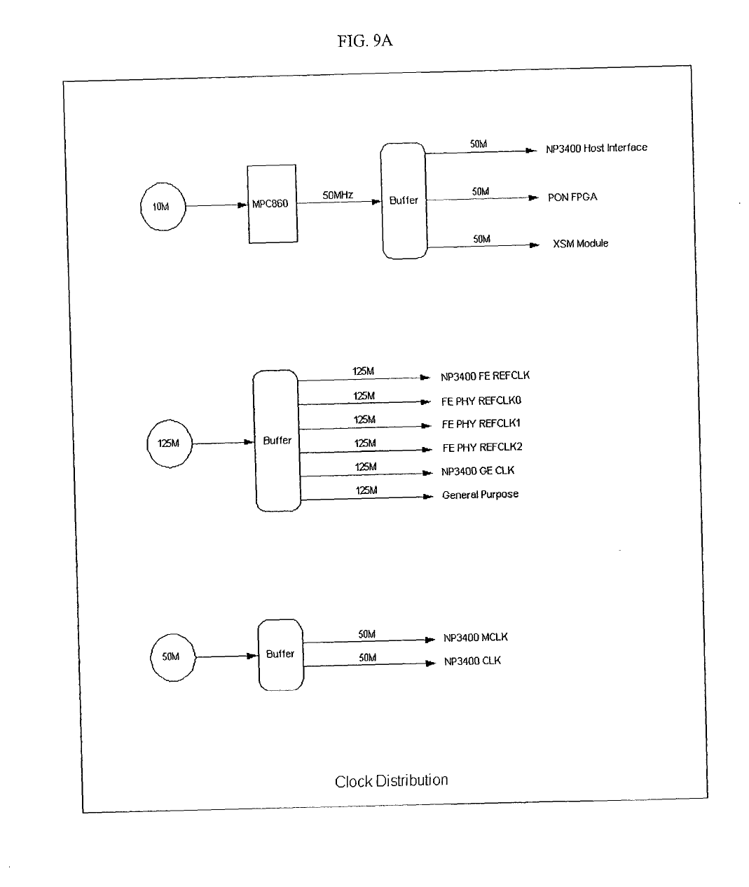

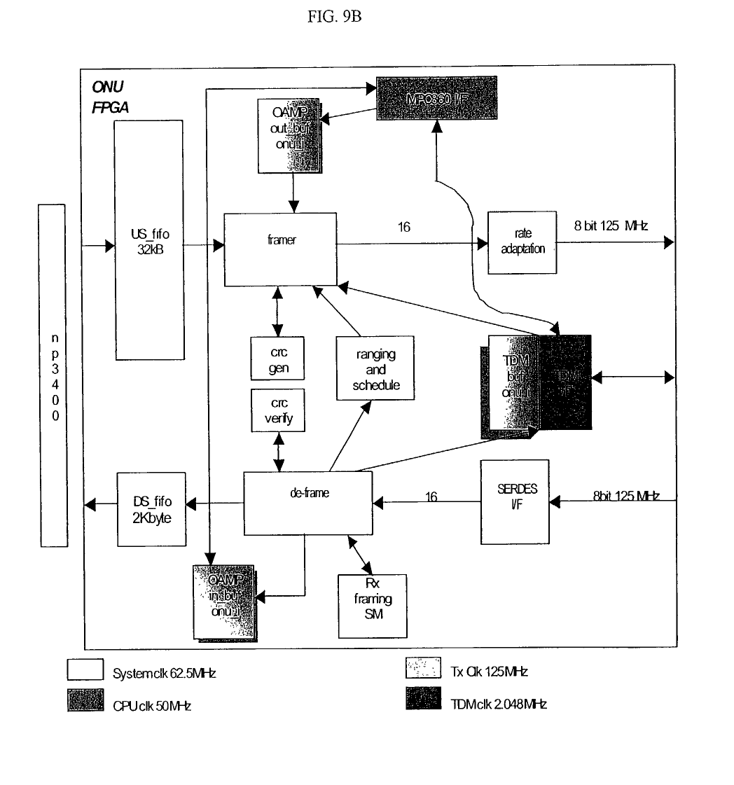

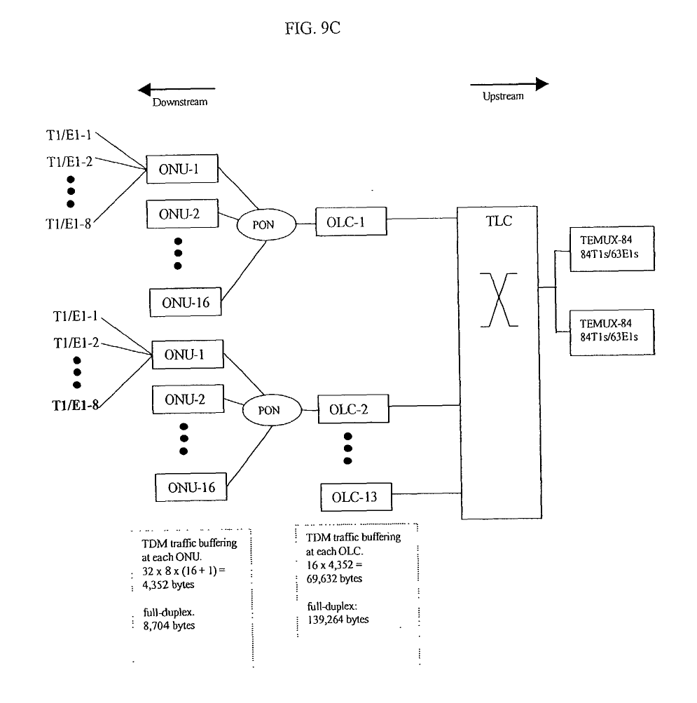

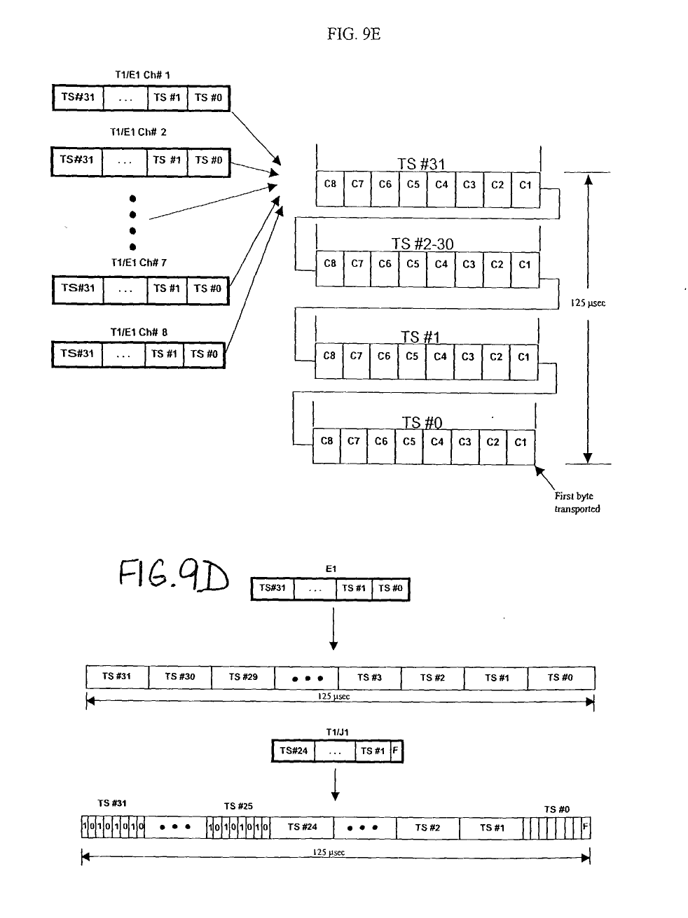

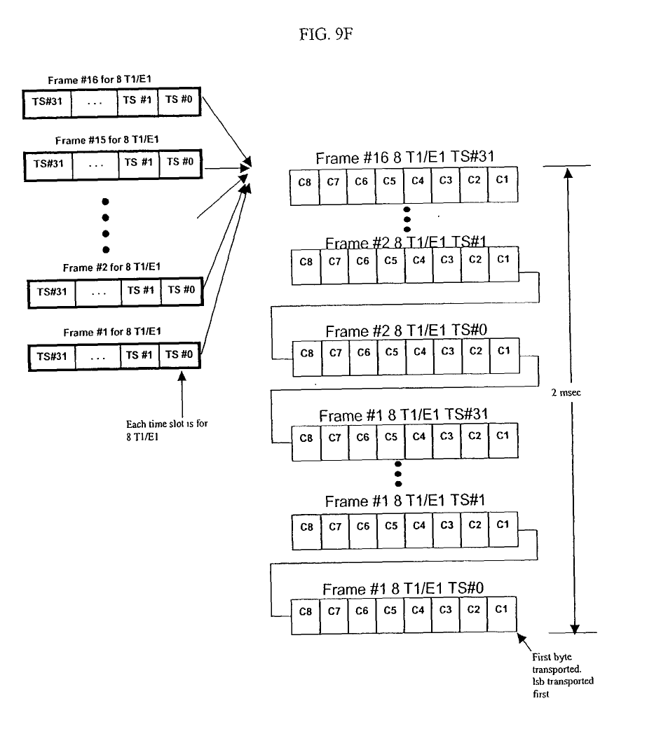

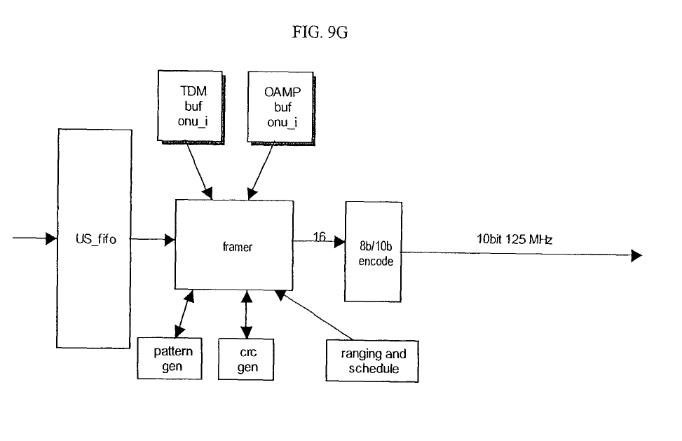

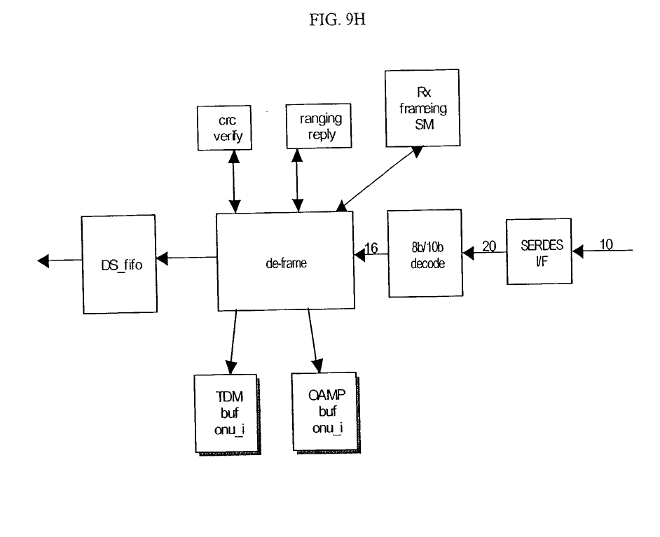

ONU Board Clock Distribution is illustrated in FIG. 9A.

System Capabilities are as follows for the ONU:

24 Fast Ethernet+2 Gigabit Ethernet ports

Support up to 8 T1/E1, Default 4 T1/E1 and removable module has 4 T1/E1

Supports a dedicated CPU port for management and control.

Provides a standard SMII interface for each Fast Ethernet connection and an 8B/10B interface for each Gigabit Ethernet connection.

Supports from 384 KB to 12 MB of Packet Buffer Memory per nP3400 device. This Packet Buffer is dynamically allocated across all the ports.

Supports up to 16 MB of routing table memory Packet size: 48 bytes to 16 KB-1

On-chip Packet Classification CAM (Policy Engine) and interface for nPC2110 XSM External Search Machine (external search coprocessor)

ONU FPGA Architecture is based on an Altera APEX20K400 FPGA. This FPGA is to be used to enable the connection between NP3400 and PON PHY. As an extension of Gigabit Ethernet MAC, the FPGA performs synchronization, OAM&P, framing and de-framing functions. FIG. 9B illustrates the ONU FPGA Block Diagram.

The ONU features are as follows:

Support up to 1 OAM&P message queue for downstream and 1 queue for the upstream. (160B each)

Support up to 8 T1/E1 connections and configurable number of active T1/E1.

Support slave mode PowerPC bus mode

Assemble HSF and non-diagonal sub-frames from data buffer and TDM buffers.

Respond to the ranging request and schedule up-stream transmission based on the range information from OLC

Statistical counters, up-stream PON frame count, receiving error frame count.

Performance monitoring, link status, PRPG test, etc.

PON system bandwidth allocation and modification

PON system error monitoring and alarm generation

Steps OLT FPGA Need to Perform in Ranging Process:

1. set offset delay to zero, send the ranging request with out-of-range status at the sub-frame prior to the diagonal sub-frame for a specific ONU_I;

2. Expect the ranging reply from ONU_I

3. If the ranging reply arrives before the end of the next sub-frame, i.e. the diagonal sub-frame, calculate the time count from the moment the reply arrives to the end of the diagonal sub-frame. Got to 4. else ONU_I is not there or too far away.

4. If the status is out-of-range, The count is the offset delay value; else if the status is ranged, the count should be equal to the offset delay value, compare the value difference against the out-of-range threshold.

5. Wait till the same diagonal sub-frame time slot in the next supper-frame, assemble a ranging request frame with the offset delay value and ranged status in the request.

6. go to step 2.

Steps ONU_i FPGA Need to Perform in Ranging Process and Synchronizing with OLT:

1. Continuely look for the COMMA_0 and COMMA_1 code groups. Once they are found, reset the RX counter. The RX counter counts for the 125 us time slot. Look for the HSF with an ID of ONU_I_I. (NOTE: The ONU ID value are set through a on-board DIP switch. The factory DIP setting should be hex FF, which is an in-valid value, a craftman will set the DIP to a valid value.)

2. Once its HSF is found, buffer the 11 range request bytes and verify its CRC, delay 50 us+the delay offset value, start/reset the TX counter, assemble an up-stream range frame, with the same status from OLT, and send it up-stream.

3. go to step 1.

NOTE: the TX counter is based on the recovered down-stream clock, (loop timing mode).

### PON TDM Sub-system Overview

The TDM sub-system is depicted in FIG. 9C. The following is a summary of how each card, in the TDM sub-system, services the T1 s/E1 s TDM streams:

Each ONU can service up to 8 T1/E1 TDM streams.

Each OLC, via the PON, services 16 ONUs.

The TLC services 13 OLC.

Thus, a total of 8×16×13=1664 T1/E1 s can be serviced by the TLC. However, since the equivalent of 2 PMC Sierra's TEMUX-84 chips are connected at the TLC, on the upstream side, the 1664 possible T1/E1 s are limited to 168 T1 s, or 126 E1s (This limitation is imposed by the TLC board's front panel because of only having enough space for 6 BNC connector pairs). So, out of the 1664 possible T1/E1 s in a PON TDM sub system of the type described herein, only 168 T1s, or 126 E1 s, can be enabled to transport TDM stream to the TEMUXes. TDM traffic is limited to either E1, or T1, but not both.

Starting at the ONUs: Since both T1 and E1 signals must be supported, a frame structure that will support both types of TDM streams will be used. An E1 TDM stream has 32 timeslots per each frame, whereas a T1 TDM stream has 24 timeslots and 1 bit of framing per each frame. Thus, a frame structure with 32 timeslots is used so that both E1 and T1 frames will fit in 32 time slots. For E1, the 32 timeslots are used as depicted in FIG. 9D. For T1, the first 25 timeslots (the first time slot is for the framing bit) are used and the rest of the timeslots (26 through 32) are filled with a repeating “0b1010_{—}1010” bit pattern. The T1 mapping is depicted also in FIG. 9D.

Since each ONU may transport 8 T1/E1 s to the OLCs, the 32 timeslot frames from each of the 8 T1/E1 s at the ONU are byte interleaved as illustrated in FIG. 9E If a T1/E1 s is not enabled, the T1/E1 timeslots of the disabled T1/E1 will be filled with a repeating “0×1010_{—}1010” bit pattern. Other embodiments may choose to not transport the unused T1/E1 timeslots in order to reclaim this bandwidth for other types of traffic.

However, since the current PON requires one ONU to transmit/receive once every 2 msec (as shown in FIG. 9F), the ONU must accumulate 16 frames worth of data for each T1/E1 channel (8 T1/E1 s per ONU) and format them into the ONU-OLC frame structure before transmitting in the designated TDM burst to the OLC. The 16×8 T1/E1 frame structure is described in FIG. 9F. The actual buffering is required to be 16 frames+1 frame in order to compensate for aligning the 16 frames, to be transported, unto the ONU's PON TDM timeslots.

| | | Destination | Source | Type/ | | |
|---|---|---|---|---|---|---|
| Preamble | SFD | Address | Address | Length | Data | FCS |
| 7 | 1 | 6 | 6 | 2 | 46 . . . 1500 | 4 |

The Sequence of Action in Framer Block:

1. Start the TX counter and keep track of the time slots;

2. Insert and send common header bytes for both diagonal and non-diagonal sub-frames. IF this is a diagonal sub-frame, GO TO 3; ELSE IF this is a non-diagonal sub-frame, GO TO 5.

3. Assemble the diagonal sub-frame with ranging requests.

4. Insert HW OAM&P frame. HW OAM&P frame format is described elsewhere;

5. Insert TDM data; TDM data are read from the TDM buffers and append TDM channel ID and BIP8.

6. If the OAM&P message buffer is enabled, insert OAM&P message MAC frame. Software is supposed to write the OAM&P messages into an ONU-specific buffer and set ONU_I_msg_rdy bit. FPGA sees the ONU_I_msg rdy bit is set, it will build a MAC frame for the OAM&P message and clear the ONU_I_msg_rdy bit after the frame is completed. The message length information needs to be conveyed by software through a registers or the first byte of the message.

7. Keep track of the frame size and remaining time slot, if the next Ethernet data frame length exceed the remaining time slot window. Stop transfer data from the Ethernet FIFO; fill the remaining window with IDLE characters.

8. TX counter indicates the next time-slot boundary, repeat from 2, while proceed to 10

9. The SERDES has a 10-bit interface. The output from frame assembling is 16 bits bus to feed to 8b/10 encoder logic.

NOTE:

1. The Upstream FIFO size is selected to be 16×32K.

2. The size of OAM&P message buffer is 256 bytes for each ONU.

3. Up-stream path registers including:

a. Up-stream PON frame counts

b. Up-stream (US) Ethernet FIFO control and status: reset_fifo, fifo_empty, fifo_full, fifo_overrun.

c. US FIFO high water mark register, if the threshold is exceeded, the TXFULL signal is asserted to stop the data flow from NP3400.

d. Interrupt status register, fifo_overrun, ranging complete

4. The last logic block on the transmitting path is SERDES interface block. It is different for Gigabit product and 125 Mbps demo product. For demo version release, external SERDES chip is not used. The FPGA will have a serial data output and output clock. The SERDES interface block performs parallel (20 bit) to serial conversion. Output clock is 125 MHz. The internal clock is 62.5 MHz, but enable is asserted every 10 cycles of the 62.5 MHz.

5. In the current product, 10 bit SERDES is used. The 8b10b encoder block is directly connected to the external SERDES. Output clock is 125 MHz.

### Upstream TDM Data Flow

1. ONU TDM interface receives 4 to 8 channels of T1/E1 stream from T1 framers, The frame sync pulse marks the starting of time slot 1. Write the TDM in a byte interleaved fashion into the TDM buffer. The data format inside the TDM buffer is illustrated as in the following table.

2. The provisioned T1/E1 channels are controled by a FPGA register, address=0×400403A. The LSB 8bit are used for control the enabled T1/E1 channels. If there are 2 T1/E1 being provisioned, for instance, they are channel 2 and channel 6. The TDM channel enable register need to be set to 0×22. FPGA will perform the packing of the 2 T1/E1 data into the PON framing structure and extract the data again in the OLC and subsequently pass on to TLC. The packing and extraction TDM data with PON frame is transparent to the user.

3. Once the TDM burst opportunity comes for the specific ONU, ONU reads the TDM data from the buffer and insert them to the PON frame as described in step 5. The opportunity is determined by the column number of the super frame. The synchronization of the column and row number is done through ranging. Buffer size is 32×32×8 bytes.

Buffer data format for TDM data to/from OLC

| | | |
|---|---|---|
| F0-C0-S0 | | |
| F0-C1-S0 | | |
| F0-C2-S0 | | |
| . . . | | |
| F0-C7-S0 | 8 | bytes |
| F0-C0-S1 | | |
| F0-C1-S1 | | |
| . . . | | |
| F0-C7-S1 | | |
| . . . | | |
| F0-C7-S31 | 8x32 | bytes |
| F1-C0-S0 | | |
| . . . | | |
| F2-C0-S0 | | |
| . . . | | |
| F15-C7-S31 | 16x8x32 | bytes |

NOTE:
F0-C1-S3 is short form of “T1 Frame #0, T1 Channel #1, and Time Slot #3”.

### Buffer Data Format for TDM Data to/from OLC

The Sequence of Action in De-frame Block:

1. Once the external CDR device has locked onto the data stream, de-frame block will get data from the 8 b/10 b decoder and monitor the K_OUT signal for the comma detection and look for HSF_ID. If found, start the RX framing state machine to make sure the frame boundary has been correctly identified. If 3 good sub-frames have been received, Rx framing state machine declares that the ONU is in-frame. If 4 bad sub-frames have been received, Rx framing state machine thinks the ONU is out-of-frame.

2. Once the ONU is in-frame, ONU looks for the sub-frame type, if it is a diagonal sub-frame, go to 3; else if this is a non-diagonal sub-frame, go to 5.

3. Extract the 11 bytes of ranging information, check the ranging status and start/move in the ranging state machine

4. Extract the hardware OAM&P messages; the length of this kind of message is carried in the OAM_ID word. The action after obtain the message is TBD.

5. Extract TDM data bytes, and store the TDM into the appropriate TDM FIFO, if the BIP8 verification fails, the FIFO pointer should be restored.

6. Extract the ONU_specific OAM&P messages; After the OAM&P messages have been verified and completely written to the ONU_I specific message buffer, FPGA generates a service-level interrupt. The software is supposed to respond to the interrupt and check the interrupt status and pick up the messages from the corresponding buffer memory.

7. Extract the Ethernet data frame; write them to the down-stream FIFO. If the layer2 bridging function is enabled, the same Ethernet data frame will also be written to LAN FIFO. Meanwhile, monitor the RX counter and watch for the time slot boundary; If the IDLE patterns, ignore the idle data till the end of time slot.

8. Go to 1.

The DS FIFO size is selected to be 2Kwords long. It monitors the RXFULL signal from nP3400, Ethernet data transfer takes place whenever the FIFO is non-empty and the nP3400 is not full.

NOTE:

Down-stream path registers including:

Down-stream Ethernet frame counts

Down-stream (DS) Ethernet FIFO control and status: reset_fifo, fifo_empty, fifo_full, fifo_underrun.

DS FIFO high water mark register, if the threshold is exceeded, the FIFO is considered full. After DS FIFO is full the receiving Ethernet frame will be dropped.

Interrupt status register, us_fifo underrun,

### Downstream TDM Data Flow

1. Upon receiving TDM burst as described in step 5, ONU writes the extracted TDM data to one downstream TDM buffer. The data format inside the buffer is shown in above table. It is byte interleaved for 8 channels of T1/E1.

2. Clocked by the TDM clock 2.048 MHz, ONU T1 interface reads the T1/E1 data from the buffer and transmits them to T1 parallel to serial conversion block. ONU also generates a frame sync pulse for all the 4 or 8 channel of T1's. The frame sync marks the transmission of the time slot #1.

NP3400 Interface: RGGI (nP3400 stack port) interface is used for its simplicity. The RGGI interface block handles the framing and flow control.

SERDES Interface: If the SERDES is 10 bit Gigabit Ethernet SERDES, like Vittese VSC7123, the receiving interface has 2 complementary half rated clock, Rxclk and RxclkN. The 10bit data are latched at the alternating rising edge of clocks. The FPGA interface logic need to have a simple state machine to identify the state of receiving and leading data byte. The internal logic clock is the lagging clock; and internal data bus is 20 bits wide.

If the SERDES is 20 bit Gigabit Ethernet SERDES, like AMCC S2046, the receiving interface has one 62.5MHz clock and the data bus is 20 bit wide.

The 8b/10b decoding logic is after 10 bit to 20 bit conversion logic. The decoding logic is concatenating 2 8b/10b decoders. The running disparity of the first 10 bit data is used as disp_in for the second 10 bit data; the running disparity of second 10 bit is used as disp in for the next 20 bit of data.

MPC860 Interface: MPC860 local bus clock is 50 MHz. Data bus is 16 bit wide. Address bus is 28 bit wide. FPGA drives two interrupt lines. The interrupt lines are classified as exception-level and service-level interrupt. The exception-level interrupt has a higher priority. The wait state is at least 4.

Exception-level: framer/CRC errors, FIFO errors, Ranging drift out of range. Service-level: ranging completion, OAM&P message received.

Note: MPC8260 has different bus interface, if the FPGA will be used with a MPC8260, the CPU interface block need to be re-designed respectively.

TDM Framer Interface is as follows on the ONU Side:

ONU has 8-channel output from 2 T1 -framers. On a per T1 channel basis, it keeps the F-bit and forms a 32 byte packet and store them into a TDM FIFO. The TDM FIFO, therefore, will need 8 bits wide by 544 deep. The TDM interface block on the ONU packs the TDM bytes from the provisioned TDM FIFOs into the PON frame structure. The bytes from different TDM FIFO are interleaved.

TDM Framer Interface is as Follows on the OLC Side:

One OLC will aggregate up to 128 T1 streams. OLC FPGA extracts the interleaved TDM data bytes and writes them to an ONU specific TDM FIFO. Thus, there are 16 FIFOs and each FIFO is at least 32*8*8 deep and 32 bit wide in size. The actual implementation may use 32 bit s wide by 2048 deep FIFOs. The TDM interface generates a continuous 38.88 MHz byte stream to the TLC line card. If any of the 16 FIFO has at least one frame, the block reads from the 16 FIFOs or a fixed idle data pattern, in the case that corresponding FIFO has no frame. The 38.88 MHz byte stream is byte interleaved from the 16 FIFOs

ONU MAC FPGA will use Xilinx VirtexII, XC2V1000-4FG456C. It is a fine-pitch ball grid array package, with 324 user I/O pins. The XC2V1000 has sufficient internal memory. It does not require any external memory.

Clock Pin assignment is as follows.

Receiving SERDES output clock rxclk and rxclk_n of 62.208 MHz.

Microprocessor MPC860 clock is 50 MHz.

NP3400 clock npClk is 62.5 MHz;

Transmitting SERDES clock txclk 124.416 MHz, this clock needs to be divided by 2 using a DLL and the resulting clock drives internal logic.

T1 framer interface clocks, txclk and rxclk with a frequency of 2.048 MHz.

Total 7 clocks and 1 DLL.

### Memory Map

| Block Name | Address Range |
|---|---|
| FPGA chip select (CS6) | 0x400 0000 |
| Down stream OAM&P message buffer | 0x400 0000-0x400 004F |
| Up stream OAM&P message buffer | 0x400 2000-0x400 204F |
| Register address range | 0x400 4000-0x400 7FFF |
| US FIFO Memo | 0x401 0000-0x401 FFFF |
| DS FIFO Memory | 0x402 0000-0x402 FFFF |
| TDM US FIFO memory | 0x400 6000-0x400 7FFF |
| TDM DS FIFO memory | 0x400 8000-0x400 9FFF |

### Register Map

| Offset | | | Default | | |
|---|---|---|---|---|---|
| (Hex) | Name | Description | Value | Width | Operation |

OAM&P Registers

| | | | | | |
|---|---|---|---|---|---|
| 00 | BCR | Basic setting and loop-back begin | 0x0000 | 16 | RW |
| 02 | GTC | guard time number and pattern | 0x08bc\| | 16 | RW |
| 04 | PAC | Preamble number and pattern | 0x08bc\| | 16 | RW |
| 0A | LPST | Loop-back status (ONU specific) | | 16 | R |
| 0C | RSR | Reset status register | 0x0000 | 16 | RW |
| 0E | RMR | Reset mark register | 0x0000 | 16 | RW |
| 12 | LPTAG | Loop-back tag value | 0xa26b | 16 | RW |
| 14 | UST | ONU PON status | | 16 | R |
| 16 | TEN | TDM channel enables | | 16 | RW |
| 20 | LPTR | Loop-back types register | 0x0000 | 16 | RW |
| 22 | CSR | Clock source register | | 16 | R |
| 26 | TCR | Test comma register | 0x1c1c | 16 | RW |
| 3C | AFMSZ | Auto frame size (32-800) | 0x080 | 10 | RW |
| 40 - 5E | BMP | BW allocation bitmap for ONU | 0x0001 | 16 | RW |
| 60 | DSBCS | Down Stream OAM buffer status | | 16 | RW |
| 6A | USBCS | Up Stream OAM buffer status | | 16 | RW |
| 80 | | Onu id and FE/TDM config control | | | |
| A0 | IDR | Init done register | | 16 | RW |
| A2 | | Disable onu id filter | 0x0001 | | |
| B0 | | Ranging offset | | | |

Up-stream Control and Status Registers

| | | | | | |
|---|---|---|---|---|---|
| 400 | USFS | US FIFO Status | | 16 | R |
| 402 | USFC | US FIFO high water mark | 0x0000 | 16 | RW |
| 414 | UFWP | US FIFO write pointer | | 16 | R |
| 416 | UFRP | US FIFO read pointer | | 16 | R |
| 408 | | US RGGI parity error count | | | |

Down-stream Control and Status Registers

| | | | | | |
|---|---|---|---|---|---|
| 480 | DSFS | DS FIFO Status | | 16 | R |
| 482 | DSFC | DS FIFO high water mark | 0x0000 | 16 | RW |
| 492 | UFWP | DS FIFO write pointer | | 16 | R |
| 494 | UFRP | DS FIFO read pointer | | 16 | R |

Counter Control and Status Registers

| | | | | |
|---|---|---|---|---|
| 500 | CCR | Counter command register | 16 | RW |
| 502 | CMR | Counter most magnificent bits register | 16 | R |
| 504 | CLR | Counter least magnificent bits register | 16 | R |

Interrupt Registers

| | | | | | |
|---|---|---|---|---|---|
| 580 | EINTS | Exception interrupt status | | 16 | R |
| 582 | EINTM | Exception interrupt mask | 0x0000 | 16 | RW |

[image]

[image]

[image]

[image]

[image]

[image]

[image]

[image]

[image]

[image]

[image]

What is claimed is:

1. A method of communicating in a time division multiplexed manner over a passive optical network, the method comprising:
transmitting a plurality of first frames of variable size in one portion of a time slot, each first frame comprising source address, destination address, data and a cyclic redundancy check (CRC) value; and
transmitting a predetermined number of second frames of fixed size in another portion of said time slot, each second frame comprising time-division-multiplexed (TDM) traffic, wherein the TDM traffic has original timing provided by an external source.

2. The method of claim 1 wherein each second frame lacks destination address, source address and length of data, and each first frame includes length of said first frame.

3. The method of claim 1 wherein the second frames have a format in conformance with a synchronous digital hierarchy selected from a group consisting of (SONET and SDH).

4. The method of claim 1 further comprising, prior to said transmittings:
transmitting a predetermined bit pattern.

5. The method of claim 4 wherein the predetermined bit pattern includes a plurality of comma characters for use by an 8B/10B decoder.

6. The method of claim 4 wherein transmission of each first frame comprises
transmitting a plurality of comma characters and transmitting Ethernet message length.

7. The method of claim 1 further comprising, prior to said transmittings:
determining whether or not a first frame can be included in said plurality of first frames by comparing a length of said first frame with a number of bytes that can be transmitted in said time slot after said predetermined number of second frames are transmitted and after transmission of all first frames in said plurality except said first frame.
